(19) United States
(12) Patent Application Publication
(10) Pub. No.: US 2026/0164283 A1
(43) Pub. Date: Jun. 11, 2026

(54) Cell Activation Technique

(71) Applicant: Telefonaktiebolaget LM Ericsson (publ), Stockholm (SE)

(72) Inventors: Venkatarao Gonuguntla, Sundbyberg (SE); Antonino Orsino, Kirkkonummi (FI); Zhixun Tang, Beijing (CN); Muhammad Ali Kazmi, Sundbyberg (SE)

(21) Appl. No.: 19/127,310

(22) PCT Filed: Nov. 7, 2023
(86) PCT No.: PCT/EP2023/081058

§ 371 Date: May 5, 2025

(30) Foreign Application Priority Data
Nov. 7, 2022 (WO) PCT/CN2022/130373

(51) Int. Cl. H04W 24/10; H04B 7/06; H04B 17/318; H04W 36/00

(52) U.S. Cl. CPC H04W 24/10; H04B 7/0626; H04B 17/328; H04W 36/00692

(57) ABSTRACT

A technique for activating a cell (502) of a radio access network, RAN (500), for a radio device (100; 1000; 1291; 1292; 1330) is described. As to a method aspect of the technique performed by the radio device (100; 1000; 1291; 1292; 1330), an activation command indicative of activating the cell (502) for multi-carrier operation of the radio device (100; 1000; 1291; 1292; 1330) is received (304) from the RAN (500). Responsive to the activation command, a measurement report indicative of a measurement for the activated cell (502) is transmitted (308) to the RAN (500).

### TECHNICAL FIELD

The present disclosure relates to a technique for activating a cell. More specifically, and without limitation, methods and devices are provided for activating a cell of a radio access network for multi-carrier operation of a radio device.

### BACKGROUND

The Third Generation Partnership Project (3GPP) has defined secondary cell (SCell) activation and deactivation for radio access technologies (RATs) such as a fourth generation Long Term Evolution (4G LTE) and fifth generation New Radio (5G NR). The purpose and the mechanism SCell activation for both RATs is to temporarily boost data transmission by through the activated SCell which is a component carrier (CC) for carrier aggregation (CA). For example, CA is configured by a radio resource control (RRC) process, based on which the boosted data transmission switched on and off by means of medium access control (MAC) control element (CE) indicative of the SCell activation and deactivation, respectively. More recently, RRC signaling has been enhanced for direct activation, i.e., the RRC reconfiguration message does not only configure the SCell but also initiates the active state of the SCell at the radio device, which is generically referred to as a user equipment (UE) in 3GPP RATs.

Existing SCell activation delay requirements are based on the known and unknown conditions of the SCell to be activated. In general, if the SCell is known, SCell activation delay is X time units (e.g. X ms) and if the SCell is not known, SCell activation delay is Y time units (e.g. Y ms), wherein Y is significantly greater compared to X. Currently, the condition for whether the SCell is known or unknown is based on whether the UE has sent a measurement report related to a measurement performed on the SCell to a base station serving the UE in less than a certain maximum time period or not. The serving base station may a network node of the RAN such as a 4G eNB or a 5G gNB.

The UE may not have sent the measurement report for the SCell to the gNB but in some scenarios the SCell may still be considered as a known cell from UE side, e.g. if the UE has not moved out of the SCell coverage after the last measurement or the UE did not transmit a measurement report after the UE had been measuring the SCell within maximum time period. However, the network node serving the UE has no information about the status of the SCell, i.e., whether the SCell is known or unknown, at the UE. This may lead to an unpredictable serving cell activation delay from the network node perspective. This in turn may lead to degradation of the performance, since RAN may not be able to allocate the resources for scheduling after the activation of the serving cell.

### SUMMARY

Accordingly, there is a need for a cell activation technique that reduced an activation delay in at least some scenarios.

As to a first method aspect, a method of activating a cell of a radio access network (RAN) for a radio device is provided. The method is performed by the radio device and comprises receiving, from the RAN, an activation command indicative of activating the cell for multi-carrier operation of the radio device. The method further comprises, responsive to the activation command, transmitting a measurement report indicative of a measurement for the activated cell to the RAN.

By transmitting the measurement report responsive to the activation command, embodiments of the technique enable the radio device to indicate to the RAN (e.g., a base station currently serving the radio device) that the activated cell is known for the radio device. Alternatively or in addition, embodiments of the radio device may change a status at the RAN (e.g., a base station currently serving the radio device) considering the activated cell as unknown for the radio device, e.g., because a time period elapsed since the last (e.g., valid) measurement report for this cell was transmitted to the RAN is longer than a predefined maximum time period.

For same or further embodiments, the 3GPP document TS 38.133, version 17.7.0 (or a later version) may specify a maximum time period between the last (e.g., valid) measurement report for the activated cell (e.g., a secondary cell, SCell) before the activation command is received, e.g., in order for the cell to be known for the radio device. When the maximum time period is exceeded (i.e., the cell is considered to be unknown for the radio device), RAN may refrain from preparing the scheduling of the radio device. As a consequence, there may be an activation delay, e.g. when a valid CSI report is received at the RAN. The measurement report transmitted prior to transmitting a valid CSI report may enable the RAN to prepare for the scheduling.

The first method aspect may further comprise any feature and/or any step disclosed in the context of the below-mentioned second method aspect, or a feature and/or step corresponding thereto, e.g., a receiver counterpart to a transmitter feature or step.

Herein, the “activated cell” may refer to the cell for which the activation command is received or will be received, e.g. including steps before the receiving of the activation command. In other words, the “activated cell” may refer to the “cell being activated” or the “cell to be activated”. Unless stated otherwise or clear from context, the “activated cell” may be briefly referred to as “the cell”.

Since the measurement report is transmitted responsive to the activation command, the measurement report may also be referred to as activation-triggered measurement report.

Herein, referring to the RAN may refer to a base station (e.g., network node) of the RAN, e.g., a base station currently serving the radio device (e.g., in a PCell).

The activated cell may be a serving cell or a non-serving cell (e.g., at the time of activating the cell), e.g., by means of direct activation. Alternatively or in addition, the activated cell may be a cell in addition to a serving cell or may replace a serving cell.

For example, the radio device may know the cell because the radio device has not been mobile relative to the activated cell between the last measurement for the activated cell and the receiving of the activation command for the activated cell.

In technical parlance, a “measurement for the activated cell” (or a “measurement performed for the activated cell”) may mean a “measurement performed on the activated cell”. Similarly, a measurement report for the activated cell may mean a measurement report related to the measurement performed on the activated cell.

Herein, the multi-carrier operation may refer to radio links between the RAN and the radio device and/or may use multiple carriers. The multiple carriers may comprise radio carriers and/or component carriers (e.g., frequency blocks assigned to the radio device). The multiple carriers may also be referred to as cells. For example, for multi-connectivity (MC), e.g., dual connectivity (DC), the multiple carriers may correspond to a master cell or a master cell group (MCG), e.g., from master base station, and one or more secondary cells or one or more secondary cell groups (SCGs), e.g., from one or more secondary base stations. Alternatively or in addition, for carrier aggregation (CA) the multiple carriers may correspond to the multiple component carriers (CCs).

The activated cell (e.g., according to the first method aspect) may be a secondary cell (SCell). Alternatively or in addition, the multi-carrier operation may comprise carrier aggregation (CA).

The activated cell may be a secondary cell (SCell) for carrier aggregation (CA), e.g. in a master cell group (MCG) or in a secondary cell group (SCG).

Alternatively or in addition, the multi-carrier operation comprises CA using multiple component carriers (CCs), which may be referred to as cells. The activated cell may use one or a subset of the CCs.

The activated cell (e.g., according to the first method aspect) may be a primary secondary cell (PSCell) of a secondary cell group (SCG) or a secondary cell (SCell) of the SCG. Alternatively or in addition, the multi-carrier operation may comprise dual connectivity (DC).

Alternatively or in addition, the activated cell may be a primary cell of a SCG, i.e., a primary secondary cell (PSCell), e.g. for multi-connectivity, for example dual connectivity (DC), or coordinated multi point (COMP) operation. The activating of the cell may initiate DC by performing a further random access to the PSCell.

Alternatively or in addition, the activated cell may be a primary cell (PCell), i.e. a cell (e.g., under a master cell group, MCG) in which the radio device first initiates random access (e.g., by transmitting a random access preamble on a random access channel, RACH). The activated cell may be a target cell for mobility of the radio device, e.g., for a handover of the radio device from a source cell to the target cell.

The PCell and the PSCell may be collectively referred to as the special cell (SpCell) of the respective cell group (i.e., of the MCG or the SCG).

Alternatively or in addition, the method may be applied to multi-carrier operation including at least two serving cells, e.g., at least two SpCells for control signaling in each group, e.g., the PCell (i.e., the primary cell of the MCG) or the PSCell (i.e., the primary secondary cell, which is the primary cell of the SCG). Each cell group may further comprise zero, one or more SCells. The SCG may be activated or deactivated by the PCell, e.g., by means of the activation command.

The measurement report (e.g., according to the first method aspect) may be transmitted without performing a further measurement for the activated cell after the receiving of the activation command. Alternatively or in addition, the measurement report may be based on a measurement for the activated cell performed prior to the receiving of the activation command. Alternatively or in addition, the measurement report may be based on a measurement for the activated cell that was not reported to the RAN prior to the receiving of the activation command.

The activated cell may be known at the radio device based on the measurement for the activated cell performed prior to the receiving of the activation command. The measurement performed prior to the receiving of the activation command may also be referred to as an earlier measurement.

The measurement performed prior to the receiving of the activation command may comprise measuring at least one of a RSRP and a RSRQ of the SSB (e.g., a primary synchronization signal, PSS, and/or the SSS) and/or the CSI-RS of the activated cell.

The method (e.g., according to the first method aspect) may further comprise determining whether to transmit the measurement report dependent on one or more rules. Alternatively or in addition, the measurement report may selectively be transmitted according to a result of the determining. Alternatively or in addition, the method may further comprises determining whether or not the radio device has a valid measurement report for the activated cell to transmit. Alternatively or in addition, the measurement report may selectively be transmitted if the radio device has a valid measurement report for the activated cell to transmit.

Alternatively or in addition, the transmitted measurement report may comprise the valid measurement report. Alternatively or in addition, the transmitted measurement report may be indicative of the existence of the valid measurement report and the valid measurement report may be transmitted separately.

Alternatively or in addition, the method further comprise determining whether or not the radio device knowns or sufficiently knows the activated cell. Alternatively or in addition, the measurement report may selectively be transmitted if the radio device knowns or sufficiently knows the activated cell. Alternatively or in addition, the transmitted measurement report may comprise the knowledge about the activated cell. Alternatively or in addition, the transmitted measurement report may be indicative of the status of the activated cell being known or sufficiently known and the knowledge about the activated cell is transmitted separately.

Herein, a valid measurement report may be a valid channel state information, CSI, report. A valid measurement may be a measurement that corresponds to (e.g., that is mapped or that is mappable to) valid measurement report.

The method (e.g., according to the first method aspect) may further comprise after the receiving of the activation command and/or after the determining whether to transmit the measurement report and/or after the transmitting of the measurement report and/or before transmitting a valid channel state information (CSI) report, performing fine time synchronization relative to the activated cell, optionally based on a secondary synchronization signal (SSS) or a synchronization signal block (SSB) received from the activated cell. Alternatively or in addition, the method may further comprise after the receiving of the activation command and/or after the determining whether to transmit the measurement report and/or after the transmitting of the measurement report and/or before transmitting a valid channel state information (CSI) report, measuring a reference signal received power (RSRP) and/or a reference signal received quality (RSRQ) and/or a channel quality indicator (CQI) for the activated cell, optionally based on the SSB and/or a channel state information reference signal (CSI-RS) received from the activated cell. Alternatively or in addition, the method may further comprise after the receiving of the activation command and/or after the determining whether to transmit the measurement report and/or after the transmitting of the measurement report and/or before transmitting a valid channel state information (CSI) report, performing receiver beam (RX beam) sweeping on the activated cell. The SSB may be a synchronization and physical broadcast channel (PBCH) block.

For dual connectivity (DC), the fine time synchronization (e.g., after receiving the activation command and before transmitting a valid CSI report for the activated cell) may comprise performing a random access to the primary cell of the secondary cell group (SCG), i.e., to the primary secondary cell (PSCell).

The CQI may be determined based on a reference signal received power (RSRP) or a reference signal received quality (RSRQ) of the CSI-RS and/or the SSB received from the activated cell.

The CSI report may be indicative of at least one of the RSRP, the RSRQ, and the CQI. For example, the CSI report may comprise an index of the RSRP, the RSRQ, and/or the CQI.

Herein, the measurement report, e.g., the CSI report, may be valid if (e.g., only if) at least one of the RSRP, the RSRQ, and the CQI measured (e.g., in units of dBm) for the activated cell is within a predefined range. For example, at least one of the RSRP, the RSRQ, and the CQI may be mapped to an index (e.g., a RSRP index, a RSRQ index, and/or a CQI index). An invalidity set of values for the index may correspond to an invalid measurement report (e.g., an invalid CSI report).

Alternatively or in addition, a validity set of values for the index may correspond to a valid measurement report (e.g., a valid CSI report). The validity set and the invalid set may be disjoint. For example, the measurement may be mapped to the index and/or the validity set or the invalidity set may be defined according to the 3GPP document TS 38.133, clause 10.1.6, version 17.7.0 (or later). By way of example, the RSRP indices 16 to 113 (or 17 to 112) may correspond to a valid CSI report. A RSRP index less than 16 (or 17) and/or a RSRP index greater than 113 (or 112) may correspond to an invalid CSI report.

The method (e.g., according to the first method aspect) may further comprise after the receiving of the activation command and/or after the determining whether to transmit the measurement report and/or after the transmitting of the measurement report and/or before transmitting or receiving data in the activated cell, transmitting, to the RAN, a valid channel state information (CSI) report, optionally based on at least one of the RSRP, the RSRQ, and the CQI measured for the activated cell.

A reception of the valid CSI report at the RAN may terminate an activation delay, e.g. a time required before the radio device receives scheduling (a scheduling grant or a scheduling assignment) for the activated cell from the RAN (e.g., from the serving base station) and/or before the radio device receives data in the activated cell or can transmit data in the activated cell.

The transmitted measurement report (e.g., according to the first method aspect) may not comprise results of a measurement performed for the activated cell. Alternatively or in addition, the transmitted measurement report, optionally 1 bit in the measurement report, may be indicative of the radio device having performed the measurement for the activated cell. Alternatively or in addition, the transmitted measurement report, optionally 1 bit in the measurement report, may be indicative of whether or not the measurement on the activated cell has already been performed. Alternatively or in addition, the transmitted measurement report, optionally 1 bit in the measurement report, may be indicative of whether or not the measurement on the activated cell is not older than a predefined maximum time period or has been performed within the predefined maximum time period before the receiving of the activation command. Alternatively or in addition, the transmitted measurement report, optionally 1 bit in the measurement report, may be indicative of the whether or not the radio device has a valid measurement or a valid measurement report for the activated cell. Alternatively or in addition, the transmitted measurement report, optionally 1 bit in the measurement report, may be indicative of whether or not the RAN shall allocate radio resource for the radio device in the activated cell, optionally before the radio device transmits or the RAN receives a valid measurement report for the activated cell.

If the activated cell is considered unknown at the RAN, e.g., because the last (e.g., valid) measurement report was too long ago (e.g., longer than the predefined maximum time period) or never sent (e.g., in either case because the radio device did not report its latest measurement for the activated cell), the measurement report may inform the RAN of the results of the latest measurement and/or may indicate (e.g., by a 1 bit) that the activated cell is known for the radio device. The measurement report may correspond to a “go ahead” signal for the RAN, e.g., to proceed with resource allocation on the activated cell for the radio device or to start or prepare scheduling of the radio device in the activated cell.

The method (e.g., according to the first method aspect), wherein the activation command may comprise at least one of a medium access control (MAC) control element (CE) optionally for the cell added by a previously received radio resource control (RRC) reconfiguration; or an RRC signaling, optionally indicative of a direct activation of the cell.

The activation command for direct activation may be an RRC reconfiguration message (e.g., according to the 3GPP document TS 38.331, version 17.2.0), optionally wherein a parameter sCellState is set to activated for the cell to be activated, e.g., in a CellGroupConfig information element (IE).

A directly activated cell may be a non-serving cell at the time of receiving the activation command. As a result of the activation, the cell may become a serving cell of the radio device.

The method (e.g., according to the first method aspect) may further comprise receiving, from the RAN, a configuration message that configures the radio device to transmit, to the RAN, the measurement report indicative of a measurement for the activated cell responsive to the activation command, optionally the configuration message being indicative of the one or more rules for determining when to transmit the measurement report.

The configuration message may comprise the activation command. Alternatively or in addition, receiving the activation command and receiving the configuration message may be the same step.

As to a second method aspect, a method of activating a cell of a radio access network (RAN) for a radio device is provided. The method is performed by a base station of the RAN and comprises transmitting an activation command indicative of activating the cell for multi-carrier operation of the radio device to the radio device. The method further comprises, responsive to the activation command, receiving a measurement report indicative of a measurement for the activated cell from the radio device.

The method (e.g., according to the second method aspect) may further comprise at least one of determining an activation delay for the activated cell; and scheduling the radio device with data upon completion of the activation of the cell or upon reception of a valid measurement report for the activated cell.

The method (e.g., according to the second method aspect), i.e., the second method aspect, may further comprise any feature and/or any step disclosed in the context of the first method aspect, or a feature and/or step corresponding thereto, e.g., a receiver counterpart to a transmitter feature or step.

As to another aspect, a computer program product is provided. The computer program product comprises program code portions for performing any one of the steps of the method aspect disclosed herein when the computer program product is executed by one or more computing devices. The computer program product may be stored on a computer-readable recording medium. The computer program product may also be provided for download, e.g., via the radio network, the RAN, the Internet and/or the host computer. Alternatively, or in addition, the method may be encoded in a Field-Programmable Gate Array (FPGA) and/or an Application-Specific Integrated Circuit (ASIC), or the functionality may be provided for download by means of a hardware description language.

As to a first device aspect, a radio device comprising memory operable to store instructions and processing circuitry operable to execute the instructions is provided. The radio device is operable to receive, from a RAN, an activation command indicative of activating the cell for multi-carrier operation of the radio device. The radio device is further operable to responsive to the activation command, transmit, to the RAN, a measurement report indicative of a measurement for the activated cell.

The radio device (e.g., according to the first device aspect) may further be operable to perform any one of the steps of the first method aspect.

As to another first device aspect, a radio device is provided. The radio device is configured to receive, from a RAN, an activation command indicative of activating the cell for multi-carrier operation of the radio device. The radio device is further configured to responsive to the activation command, transmit, to the RAN, a measurement report indicative of a measurement for the activated cell.

The radio device (e.g., according to the other first device aspect) may further configured to perform any one of the steps of the first method aspect.

As to a second device aspect, a base station comprising memory operable to store instructions and processing circuitry operable to execute the instructions is provided. The base station is operable to transmit, to a radio device, an activation command indicative of activating the cell for multi-carrier operation of the radio device. The network node is further operable to responsive to the activation command, receive, from the radio device, a measurement report indicative of a measurement for the activated cell.

The base station (e.g., according to the second device aspect) may further be operable to perform any one of the steps of the second method aspect.

As to another second device aspect a base station is provided. The base station is configured to transmit, to a radio device, an activation command indicative of activating the cell for multi-carrier operation of the radio device. The base station is further configured to responsive to the activation command, receive, from the radio device, a measurement report indicative of a measurement for the activated cell.

The base station (e.g., according to the other second device aspect) may further configured to perform any one of the steps of the second method aspect.

The devices may be configured to perform any one of the steps of the first and/or second method aspect. Alternatively or in addition, the devices may comprise processing circuitry (e.g., at least one processor and a memory). Said memory comprises instructions executable by said at least one processor whereby the device is operative to perform any one of the steps of the first and/or second method aspect.

Any radio device may be a user equipment (UE), e.g., according to a 3GPP specification. The radio device and the RAN (e.g., the base station, or the master base station, serving the radio device) may be wirelessly connected in an uplink (UL) and/or a downlink (DL) through a Uu interface.

In any aspect, the technique may be a method for triggering a UE measurement report during (e.g., serving) cell activation, e.g., for at least one of carrier aggregation (CA), SCell activation, operation on frequency range 2 (FR2), indicating a known or quasi-known condition of the activated cell, and as UE assistant information (e.g., for UE-assisted radio resource allocation).

Alternatively or in addition, any embodiment of a (e.g., first) method aspect performed by a UE, may comprise, when the UE receives an activation command for a (e.g., serving) cell, determining whether the UE has a valid measurement report to send (e.g., to transmit) and transmit the measurement report to reduce an activation delay (e.g., the SCell activation delay).

The radio device and/or the RAN (e.g., the base station) may form, or may be part of, a radio network, e.g., according to the Third Generation Partnership Project (3GPP) or according to the standard family IEEE 802.11 (Wi-Fi). The first method aspect and the second method aspect may be performed by one or more embodiments of the radio device and the RAN (e.g., the base station), respectively.

The RAN may comprise one or more base stations, e.g., performing the second method aspect. Alternatively or in addition, the radio network may be a vehicular, ad hoc and/or mesh network comprising two or more radio devices, e.g., a first radio device receiving the activation command according to the first method aspect and/or a second radio device (e.g., a relay radio device or a gateway) providing radio access in the activated cell to the first radio device, e.g. in a sidelink between the first and second radio devices.

Any of the radio devices may be a 3GPP user equipment (UE) or a Wi-Fi station (STA). The radio device may be a mobile or portable station, a device for machine-type communication (MTC), a device for narrowband Internet of Things (NB-IoT) or a combination thereof. Examples for the UE and the mobile station include a mobile phone, a tablet computer and a self-driving vehicle. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in a manufacturing plant, household appliances and consumer electronics.

Whenever referring to the RAN, the RAN may be implemented by one or more base stations. At least one or each of the base stations of the RAN (or a plurality of the base stations collectively) may perform the second method aspect.

The radio device may be wirelessly connected or connectable (e.g., according to a radio resource control, RRC, state or active mode) to the RAN (e.g., to the base station performing the second method aspect) and, optionally, at least one base station of the RAN.

The base station may encompass any station that is configured to provide radio access to any of the radio devices. The base stations may also be referred to as cell, transmission and reception point (TRP), radio access node or access point (AP). The base station and/or the relay radio device may provide a data link to a host computer providing the user data to the remote radio device or gathering user data from the remote radio device. Examples for the base stations may include a 3G base station or Node B (NB), 4G base station or eNodeB (eNB), a 5G base station or gNodeB (gNB), a Wi-Fi AP and a network controller (e.g., according to Bluetooth, ZigBee or Z-Wave).

The RAN may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented on a Physical Layer (PHY), a Medium Access Control (MAC) layer, a Radio Link Control (RLC) layer, a packet data convergence protocol (PDCP) layer, and/or a Radio Resource Control (RRC) layer of a protocol stack for the radio communication.

Herein, referring to a protocol of a layer may also refer to the corresponding layer in the protocol stack. Vice versa, referring to a layer of the protocol stack may also refer to the corresponding protocol of the layer. Any protocol may be implemented by a corresponding method.

As to a still further aspect a communication system including a host computer is provided. The host computer comprises a processing circuitry configured to provide user data, e.g., included in the data transmission through the activated cell. The host computer further comprises a communication interface configured to forward the user data to a cellular network (e.g., the RAN and/or the base station) for transmission to a UE. A processing circuitry of the cellular network is configured to execute any one of the steps of the second method aspect. Alternatively or in addition, the UE comprises a radio interface and processing circuitry, which is configured to execute any one of the steps of the first method aspect.

The communication system may further include the UE. Alternatively, or in addition, the cellular network may further include one or more base stations configured for radio communication with the UE and/or to provide a data link between the UE and the host computer using the first and/or second method aspects.

The processing circuitry of the host computer may be configured to execute a host application, thereby providing the user data and/or any host computer functionality described herein. Alternatively, or in addition, the processing circuitry of the UE may be configured to execute a client application associated with the host application.

Any one of the devices, the UE, the base station, the communication system or any node or station for embodying the technique may further include any feature disclosed in the context of the method aspect, and vice versa. Particularly, any one of the units and modules disclosed herein may be configured to perform or initiate one or more of the steps of the method aspect.

### BRIEF DESCRIPTION OF THE DRAWINGS

Further details of embodiments of the technique are described with reference to the enclosed drawings, wherein:

FIG. 1 shows a schematic block diagram of an embodiment of a device for activating a cell of a RAN for multi-carrier operation of a radio device, which may be embodied by the radio device;

FIG. 2 shows a schematic block diagram of an embodiment of a device for activating a cell of a RAN for multi-carrier operation of a radio device, which may be embodied by a base station of the RAN;

FIG. 3 shows a flowchart for a method of activating a cell of a RAN for multi-carrier operation of a radio device, which method may be implementable by the device of FIG. 1;

FIG. 4 shows a flowchart for a method of activating a cell of a RAN for multi-carrier operation of a radio device, which method may be implementable by the device of FIG. 2;

FIG. 5 schematically illustrates a first example of a radio network comprising embodiments of the devices of FIGS. 1 and 2 for performing the methods of FIGS. 3 and 4, respectively;

FIG. 6 schematically illustrates a second example of a radio network comprising embodiments of the devices of FIGS. 1 and 2 for performing the methods of FIGS. 3 and 4, respectively;

FIG. 7 schematically illustrates a third example of a radio network comprising embodiments of the devices of FIGS. 1 and 2 for performing the methods of FIGS. 3 and 4, respectively;

FIG. 8 schematically illustrates first embodiments of the methods of FIGS. 3 and 4, respectively, for a MAC-triggered cell activation;

FIG. 9 schematically illustrates second embodiments of the methods of FIGS. 3 and 4, respectively, for an RRC-triggered cell activation;

FIG. 10 shows a schematic block diagram of a radio device embodying the device of FIG. 1;

FIG. 11 shows a schematic block diagram of a base station embodying the device of FIG. 2;

FIG. 12 schematically illustrates an example telecommunication network connected via an intermediate network to a host computer;

FIG. 13 shows a generalized block diagram of a host computer communicating via a base station or radio device functioning as a gateway with a user equipment over a partially wireless connection; and

FIGS. 14 and 15 show flowcharts for methods implemented in a communication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including a Wireless Local Area Network (WLAN) implementation according to the standard family IEEE 802.11, 3GPP LTE (e.g., LTE-Advanced or a related radio access technique such as MulteFire), for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

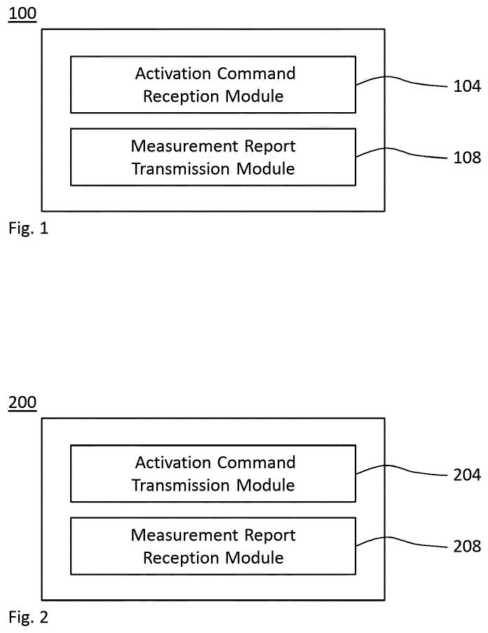

FIG. 1 schematically illustrates a block diagram of an embodiment of a device for activating a cell of a radio access network (RAN). The device is generically referred to by reference sign 100.

The device 100 comprises an activation command reception module 104 that receives an activation command indicative of activating the cell for multi-carrier operation of the radio device from the RAN. The device 100 further comprises a measurement report transmission module 108 that transmits, responsive to (e.g., the reception of) the activation command, a measurement report indicative of a measurement for the activated cell to the RAN.

Any of the modules of the device 100 may be implemented by units configured to provide the corresponding functionality.

The device 100 may also be referred to as, or may be embodied by, the radio device (or briefly: UE). The radio device 100 and the RAN (e.g., a base station) may be in direct radio communication, e.g., at least for the reception of the activation command and the transmission of the measurement report. The RAN (e.g., the base station) may be embodied by the below device 200.

FIG. 2 schematically illustrates a block diagram of an embodiment of a device for activating a cell of a radio access network (RAN). The device is generically referred to by reference sign 200.

The device 200 comprises an activation command transmission module 204 that transmits an activation command indicative of activating the cell for multi-carrier operation of the radio device to the radio device. The device 200 further comprises a measurement report reception module 208 that receives, responsive to (e.g., the transmission of) the activation command, a measurement report indicative of a measurement for the activated cell from the radio device.

Any of the modules of the device 200 may be implemented by units configured to provide the corresponding functionality.

The device 200 may also be referred to as, or may be embodied by, the RAN (e.g., a base station, or briefly: gNB). The radio device and the RAN 200 (e.g., a base station) may be in direct radio communication, e.g., at least for the transmission of the activation command and the reception of the measurement report. The radio device may be embodied by the above device 100.

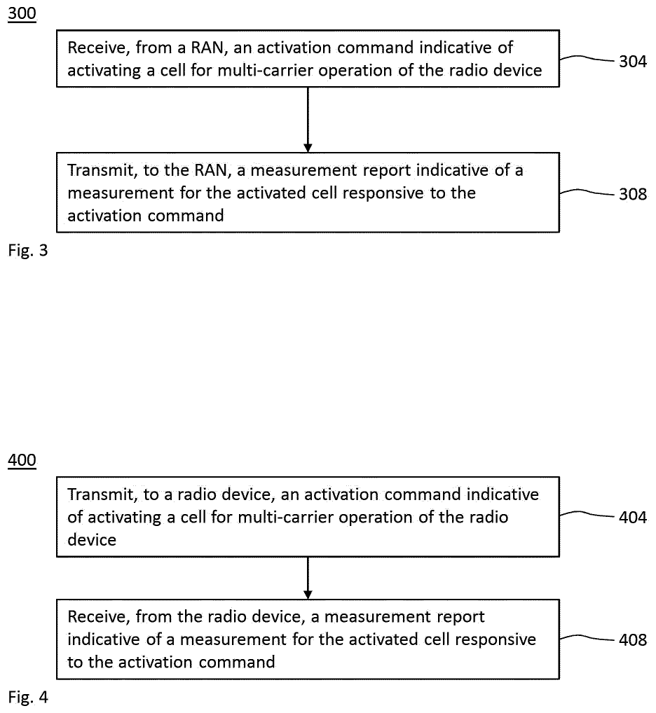

FIG. 3 shows an example flowchart for a method 300 of activating a cell of a radio access network (RAN) for a radio device. The method 300 may be performed by the radio device.

In a step 304 of the method 300, an activation command indicative of activating the cell (e.g., for multi-carrier operation of the radio device) is received from the RAN. Responsive to the activation command, a measurement report indicative of a measurement for the activated cell is transmitted to the RAN according to a step 308 of the method 300.

The method 300 may be performed by the device 100. For example, the modules 104 and 108 may perform the steps 304 and 308, respectively.

FIG. 4 shows an example flowchart for a method 400 of activating a cell of a radio access network (RAN) for a radio device. The method 300 may be performed by the RAN, e.g., by one or more base stations of the RAN, optionally by one or more base stations serving the radio device.

In a step 404 of the method 400, an activation command indicative of activating the cell (e.g., for multi-carrier operation of the radio device) is transmitted to the radio device. Responsive to the activation command, a measurement report indicative of a measurement for the activated cell is received from the radio device according to a step 408 of the method 400.

The method 400 may be performed by the device 200. For example, the modules 204 and 208 may perform the steps 404 and 408, respectively.

In any aspect, the technique may be applied to increase a data throughput in an uplink (UL) and/or a downlink (DL) and/or a direct radio communication between radio devices, i.e., a device-to-device (D2D) communication also referred to as sidelink (SL).

Each of the device 100 and device 200 may be a radio device or a base station. Herein, any radio device may be a mobile or portable station and/or any radio device wirelessly connectable to a base station or RAN, or to another radio device. For example, the radio device may be a user equipment (UE), a device for machine-type communication (MTC) or a device for (e.g., narrowband) Internet of Things (IoT). Two or more radio devices may be configured to wirelessly connect to each other, e.g., in an ad hoc radio network or via a 3GPP SL connection. Furthermore, any base station may be a station providing radio access, may be part of a radio access network (RAN) and/or may be a node connected to the RAN for controlling the radio access. For example, the base station may be an access point, for example a Wi-Fi access point.

Herein, whenever referring to a channel quality indicator (CQI, sometimes also referred to as channel quality information), the CQI may further depend on noise, a signal-to-noise ratio (SNR), interference, and/or a signal-to-interference-and-noise ratio (SINR).

Herein below, for concreteness and not limitation, the radio device 100 is referred to as a UE. The activated cell (i.e., the cell to which the activation command refers) may be referred to as a second cell Cell2. Alternatively or in addition, the RAN or the base station is referred to by network node NW1.

A scenario, which may be applied to any embodiment disclosed herein, comprises a UE 100 which is served by a first cell (Cell1, e.g., a PCell). The UE 100 is configured to activate a second cell (Cell2), e.g. based on a command or message received 304 from a network node 200.

According to a first aspect, the UE 100 configured by a first network node 200 (NW1) to activate Cell2, determines (according to a step generically referred to by reference sign 306) based on one or more rules whether to transmit 308 a measurement report related to a measurement performed (according to a step generically referred to by reference sign 302) by the UE 100 on the Cell2 to NW1. The UE 100 transmits 308 the measurement report to the NW1 200 based on the determination 306. The UE 100 further activates Cell2 during a certain time period e.g. within the Cell2 activation delay starting from the moment the UE has received 304 a message to activate Cell2 (i.e., the activation command).

In one example of the rule, the UE 100 determines 306 that it should transmit 308 the measurement report for Cell2 if the UE 100 has been requested by NW1 to send the measurement report e.g. triggered by the serving cell activation message (i.e., the activation command) or by a separate message. In another example of the rule, the UE 100 determines that it should transmit the measurement report for Cell2 if Cell2 is known or semi-known (e.g., sufficiently knows) to the UE 100. In another example of the rule, the UE 100 determines that it should transmit the measurement report for Cell2 if the UE 100 is configured by NW1 200 to transmit the report and Cell2 is known or semi-known to the UE.

According to a second aspect, a first network node 200 (NW1) configures the UE 100 to transmit 308 a measurement report related to a measurement performed 302 by the UE 100 on the Cell2 to the NW1 200 upon receiving 304 an activation command to activate the Cell2. The NW1 200 receives 408 the measurement report for the Cell2 from the UE 100.

The NW1 200 may further use the received 408 measurement report for the Cell2 200 from the UE 100 for performing one or more operational tasks. In one example, NW1 200 may configure the UE 100 to transmit (in the step 308 or in a separate step generically referred to by reference sign 312) the measurement report for the Cell2 in a separate message (e.g. pre-configures the UE 100 before transmitting 404 the activation command for the Cell2). In another example, the NW1 200 may configure the UE 100 to transmit 308 the measurement report for Cell2 in the same message transmitted 404 for the activating of the Cell2 (e.g. the Cell2 activation command).

Examples of the operational tasks are NW1 200 determining the serving cell activation delay for Cell2, scheduling the UE with data upon completion of the activation of Cell2 etc.

Examples of the serving cell are secondary cell (SCell), special cell (SpCell), e.g. primary secondary cell (PSCell). Examples of the serving cell activation procedures are SCell activation, SpCell (e.g. PSCell) activation, cell group (CG) activation (e.g. SCG activation).

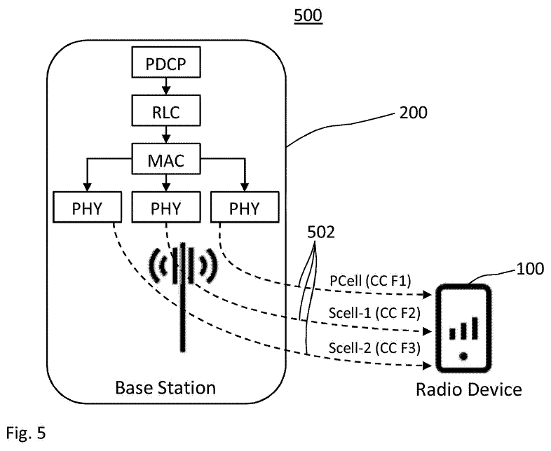

Herein, the activated cell may be one or more of the cells referred to by reference sign 502. FIG. 5 schematically illustrates a first example of a radio network 500 comprising embodiments of the radio device 100 and the base station 200 for performing the methods 300 and 400, respectively. The technique may be applied for carrier aggregation (CA), wherein the activated cell 502 may be one or more secondary cells (SCells) or one or more corresponding component carriers (CCs).

Any one of the embodiments may use carrier aggregation (CA), e.g. controlled or initiated by SCell activation according to the steps 304 and 404, optionally including at least one of the following features or steps.

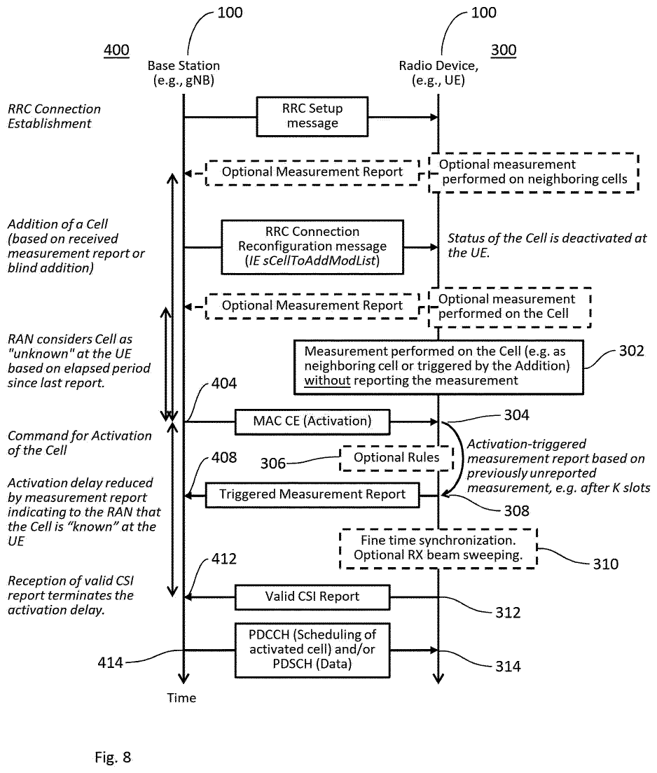

CA is generally used in 5G NR or 4G LTE systems 500 to improve UE 100 transmit and/or receive data rate. With CA, the UE 100 typically operates initially on single serving cell called a primary cell (PCell). The PCell is operated on a primary component carrier (PCC) in a frequency band. The UE 100 is then configured by the RAN (e.g., the base station 200) with one or more secondary serving cells (SCells). Each SCell can correspond to a component carrier (CC) in the same frequency band (intra-band CA) or different frequency band (inter-band CA) from the frequency band of the CC corresponding to the PCell. When the SCells are added by the RAN (also referred to as network, NW), e.g., by the base station 200, typically they will be in deactivated state for UE power saving purposes. Whenever there is a need for more data transmission to the UE 100, the NW can activate the SCells 502 for the UE 100. When the data demand is reduced, to save UE power, the one or more activated SCells 502 can also be deactivated. Activation and/or deactivation of the SCell 502 may be performed by NW as needed, e.g., according to the step 404. The NW performs activation or deactivation of the SCell 502 using a SCell activation/deactivation MAC CE command, e.g., according to below-mentioned FIG. 8 and/or wherein the contents of MAC CE command may be implemented according to the 3GPP document TS 38.321, version 17.2.0.

Typically, the SCell activation procedure (e.g., as initiated by the steps 304 and 404) can take anywhere between a minimum activation delay (e.g., on the order of a few milliseconds) to up to multiple 10's or 100's of milliseconds. Upon reception 304 of an SCell activation command (e.g., via a MAC CE), a UE 100 starts the activation procedure for the corresponding SCell, and the activation procedure is assumed to be complete (i.e., the SCell is considered activated) when UE send a valid CSI report for the SCell. When a SCell is activated, it shall be able to receive data from the NW.

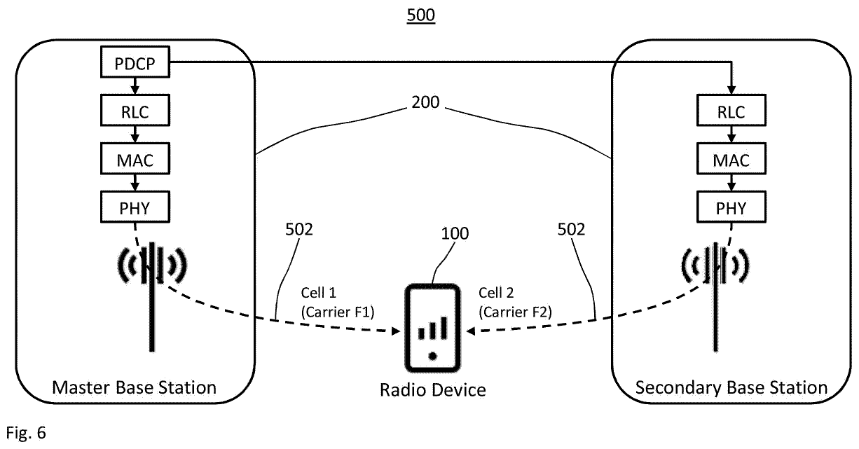

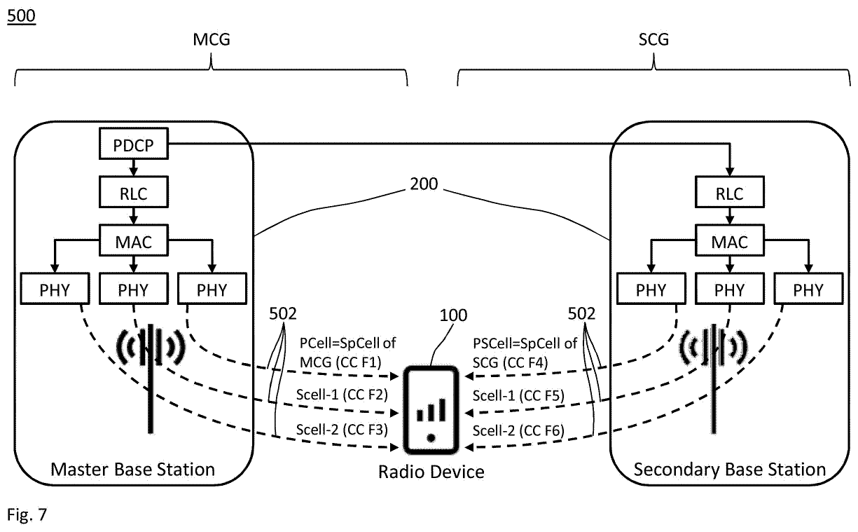

FIG. 6 schematically illustrates a first example of a radio network 500 comprising embodiments of the radio device 100 and the base station 200 for performing the methods 300 and 400, respectively. The technique may be applied for dual connectivity (DC), wherein the activated cell 502 may be one or more secondary cells (SCells) or one or more corresponding carriers (CCs), e.g. of another base station 200′ or another embodiment of the base station 200.

The technique may also be applied to the combination of carrier aggregation and dual connectivity, i.e., when a master cell group (MCG) comprises one or more cells 502, namely a PCell 502 and zero or one or more SCell 502. Alternatively or in addition, the secondary cell group (SCG) comprises one or more cells 502, namely a PSCell 502 and zero or one or more SCells 502.

FIG. 8 schematically illustrates a signaling diagram resulting from embodiments of the radio device 100 and the base station 200 performing the methods 300 and 400 in radio communication. The example illustrated in FIG. 8 comprises the activation command in a MAC CE.

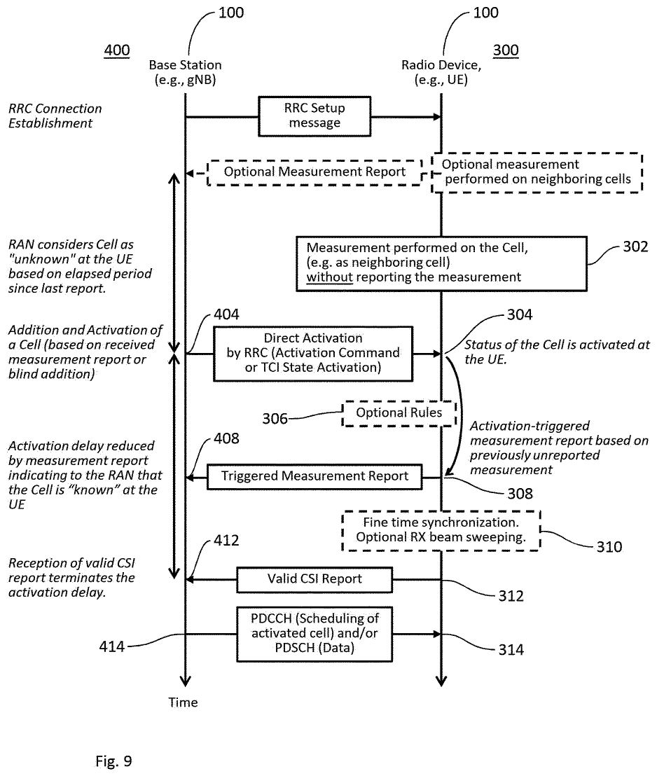

FIG. 9 schematically illustrates a signaling diagram resulting from embodiments of the radio device 100 and the base station 200 performing the methods 300 and 400 in radio communication. The example illustrated in FIG. 9 comprises the activation command in a RRC signaling.

The UE 100 is supposed to complete 310 the activation procedure based on certain minimum delay requirements, e.g. as specified in the 3GPP specifications TS 38.133, version 17.7.0, which is also referred to as a RAN4 specification. RAN4 specified many scenarios for which different delay requirements are applicable. SCell activation timeline contains, UE 100 acquiring all or subset of following procedures such as Cell search, AGC settling (may typically require one or two samples), Fine timing, which are generically referred to by reference sign 310.

The UE may perform these procedures 310 by using the reference signals such as SSB or antenna port reference signal (AP-RS) or A-TRS, etc. RAN4 defined SCell activation requirements for two scenario such as the to-be-activated SCell is known and the to-be-activated SCell is unknown. If the SCell is known, delay required for SCell activation is shorter and if the SCell is not known, delay required to activate SCell is longer as the UE 100 need to know the beams transmitted by SCell by performing receiver beam sweeping 310 in all the direction. SCell activation delay for FR1 and FR2 varies as UE need not acquire beam information for FR1 scenario.

In any embodiment, one or more of the following conditions may be applied at the RAN (e.g., the base station 200) for determining whether the activated cell 502 (e.g., an SCell) is known or unknown, e.g., unless or until the activation-triggered measurement report is received 408.

As per the 3GPP document TS 38.133, clause 8.3.2 (on SCell Activation Delay Requirement for Deactivated SCell), version 17.7.0, SCell in FR1 is known if it has been meeting the following conditions. The SCell 502 in frequency range 1 (FR1) is known (e.g., considered known from the perspective of the RAN 500) if the SCell 502 has been meeting the following conditions:
During the period equal to

$$max ( 5 \cdot measCyclesSCell , 5 \cdot DRX cycles ) ,$$

which may be an example of the maximum time period, for FR1 before the reception of the SCell activation command:
   the UE 100 has sent a valid measurement report for the SCell 502 being activated and
   the SSB measured remains detectable (e.g., according to the cell identification conditions specified in clause 9.2 and 9.3 of the 3GPP document TS 38.133, version 17.7.0).
the SSB measured during the period equal to

$$max ( 5 \cdot measCyclesSCell , 5 \cdot DRX cycles )$$

also remains detectable during the SCell activation delay (e.g., according to the cell identification conditions specified in clause 9.2 and 9.3 of the 3GPP document TS 38.133, version 17.7.0).

Otherwise, the SCell 502 in FR1 is unknown (e.g., from the perspective of the RAN 500).

For the first SCell activation in frequency range 2 (FR2) bands, the SCell 502 is known (e.g., considered known from the perspective of the RAN 500) if it has been meeting the following conditions:
During the period equal to 4 s for UE supporting power class 1/5 and 3 s for UE supporting power class 2/3/4 (which may be an example of the maximum time period) before UE 100 receives 404 the last activation command for PDCCH TCI, PDSCH TCI (when applicable) and semi-persistent CSI-RS for CQI reporting (when applicable):
   the UE has sent a valid L3-RSRP measurement report with SSB index
   SCell activation command is received after L3-RSRP reporting and no later than the time when UE receives MAC-CE command for TCI activation
During the period from L3-RSRP reporting to the valid CQI reporting, the reported SSBs with indexes remain detectable according to the cell identification conditions specified in the clauses 9.2 and 9.3, and the TCI state is selected based on one of the latest reported SSB indexes.

Otherwise, the first SCell in FR2 band is unknown. The requirement for unknown SCell applies provided that the activation commands for PDCCH TCI, PDSCH TCI (when applicable), semi-persistent CSI-RS for CQI reporting (when applicable), and configuration message for TCI of periodic CSI-RS for CQI reporting (when applicable) are based on the latest valid L1-RSRP reporting.

SCell known or unknown conditions are defined based on whether UE has reported the measurement reports to the NW. In the next section, we look at the UE measurements.

Any embodiment may use at least one of the following features or steps for one or more UE measurements, e.g., in the step 302 of the method 300.

The UE 100 performs measurements on one or more DL and/or UL reference signal (RS) of one or more cells in different UE activity states e.g. RRC idle state, RRC inactive state, RRC connected state etc. The measured cell may belong to or operate on the same carrier frequency as of the serving cell (e.g. intra-frequency carrier) or it may belong to or operate on different carrier frequency as of the serving cell (e.g. non-serving carrier frequency). The non-serving carrier may be called as inter-frequency carrier if the serving and measured cells belong to the same RAT but different carriers. The non-serving carrier may be called as inter-RAT carrier if the serving and measured cells belong to different RATs. Examples of downlink RS are signals in synchronization signal and PBCH block (SSB), channel state information reference signal (CSI-RS), cell-specific reference signal (CRS), demodulation reference signal (DMRS), primary synchronization signal (PSS), secondary synchronization signal (SSS), signals in SS/PBCH block (SSB), discovery reference signal (DRS), positioning reference signal (PRS), etc. Examples of uplink RS are signals in sounding reference signal (SRS), DMRS, etc.

Each SSB carries NR-PSS, NR-SSS and NR-PBCH in 4 successive symbols. One or multiple SSBs are transmit in one SSB burst which is repeated with certain periodicity e.g. 5 ms, 10 ms, 20 ms, 40 ms, 80 ms and 160 ms. The UE 100 is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset with respect to reference time (e.g. serving cell's SFN) etc. Therefore, SMTC occasion may also occur with certain periodicity e.g. 5 ms, 10 ms, 20 ms, 40 ms, 80 ms and 160 ms.

Examples of measurements (or measurement results) are cell identification (e.g. PCI acquisition, PSS/SSS detection, cell detection, cell search, etc.), Reference Symbol Received Power (RSRP), Reference Symbol Received Quality (RSRQ), secondary synchronization RSRP (SS-RSRP), SS-RSRQ, SINR, RS-SINR, SS-SINR, CSI-RSRP, CSI-RSRQ, received signal strength indicator (RSSI), acquisition of system information (SI), cell global ID (CGI) acquisition, Reference Signal Time Difference (RSTD), UE RX-TX time difference measurement, Radio Link Monitoring (RLM), which consists of Out of Synchronization (out of sync) detection and In Synchronization (in-sync) detection etc.

Examples of network nodes 200 are NodeB, base station (BS), multi-standard radio (MSR) radio node such as MSR BS, eNodeB, gNodeB, MeNB, SeNB, location measurement unit (LMU), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, transmission reception point (TRP), RRU, RRH, nodes in distributed antenna system (DAS), core network node (e.g. a Mobile-services Switching Center, MSC or a Mobility Management Entity, MME, etc.), Operation and Maintenance (O&M), Operational Support Systems (OSS), Self-Organizing Network (SON), positioning node (e.g. Evolved Serving Mobile Location Center, E-SMLC), etc.

The non-limiting term UE 100 refers to any type of wireless device communicating with a network node and/or with another UE in a cellular or mobile communication system. Examples of UE are target device, device to device (D2D) UE, vehicular to vehicular (V2V), machine type UE, machine-type communication (MTC) UE or UE capable of machine to machine (M2M) communication, PDA, tablet, mobile terminals, smart phone, laptop embedded equipment (LEE), laptop mounted equipment (LME), USB dongles, etc.

The term radio access technology (RAT) may refer to any RAT, e.g. UTRA, E-UTRA, narrow band internet of things (NB-IoT), Wi-Fi, Bluetooth, next generation RAT, New Radio (NR), 4G, 5G, etc. Any of the equipment denoted by the term node, network node or radio network node may be capable of supporting a single or multiple RATs.

The term signal or radio signal used herein can be any physical signal or physical channel. Examples of DL physical signals are reference signal (RS) such as PSS, SSS, CSI-RS, DMRS signals in SS/PBCH block (SSB), discovery reference signal (DRS), CRS, PRS etc. RS may be periodic e.g. RS occasion carrying one or more RSs may occur with certain periodicity e.g. 20 ms, 40 ms etc. The RS may also be aperiodic. Each SSB carries NR-PSS, NR-SSS and NR-PBCH in 4 successive symbols. One or multiple SSBs are transmit in one SSB burst which is repeated with certain periodicity e.g. 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset wrt reference time (e.g. serving cell's SFN) etc. Therefore, SMTC occasion may also occur with certain periodicity e.g. 5 ms, 10 ms, 20 ms, 40 ms, 80 ms and 160 ms. Examples of UL physical signals are reference signal such as SRS, DMRS etc. The term physical channel refers to any channel carrying higher layer information e.g. data, control etc. Examples of physical channels are physical broadcast channel (PBCH), Narrowband Physical Broadcast Channel (NPBCH), physical downlink control channel (PDCCH), physical downlink shared channel (PDSCH), sPUCCH, SPDSCH, short Physical Uplink Control Channel (sPUCCH), short PUSCH (sPUSCH), MTC PDCCH (MPDCCH), narrowband PDCCH (NPDCCH), narrowband PDSCH (NPDSCH), Enhanced Physical Downlink Control Channel (E-PDCCH), physical uplink shared channel (PUSCH), physical uplink control channel (PUCCH), narrowband PUSCH (NPUSCH), etc.

The term A-TRS for Aperiodic-temporary reference symbol used herein is a 3GPP Release 17 application of the CSI-RS for the UE measurement to settle the AGC (automatic gain control) during the secondary cell activation timeline. A-TRS can be typical NZP CSI-RS which follows the configuration from higher layer.

The term time resource used herein may correspond to any type of physical resource or radio resource expressed in terms of length of time. Examples of time resources are: symbol, time slot, subframe, radio frame, TTI, interleaving time, slot, sub-slot, mini-slot, system frame number (SFN) cycle, hyper-SFN (H-SFN) cycle etc.

Any of the above aspects and embodiments may be implemented according to any one of the following detailed embodiments.

Furthermore, any embodiment may be applied to the following scenario. The scenario comprises a UE 100 which is configured to perform one or more procedures on at least one target cell 502, which may be a serving cell or a non-serving cell. Examples of procedures are activation of the serving cell, cell change to the target cell, etc.

In one exemplary scenario, the UE 100 is configured with at least one to be activated serving cell 502 (e.g. one or more SCells, special cell such as PSCell) using 304 a message from NW node, e.g., MAC CE, RRC signaling, etc. The one or more serving cells 502 to be activated may belong to the same cell group (CG) (e.g. MCG or SCG) or different CGs. In some embodiments one or more special cell (SpCell) may be deactivated e.g., PSCell belonging to secondary cell group (SCG) in dual connectivity (DC). The deactivated SpCell can be activated 304, 404, e.g., by means of a message received 304 by the UE 100 from the primary cell group (MCG) in dual connectivity. In this case one of the serving cells to be activated may be a SpCell e.g. PSCell. The step 304, 404 for activating the serving cell 502 may be based on an RRC message (e.g., RRC signaling) from the NW node 200 (e.g., according to FIG. 9) or MAC message (e.g., MAC CE command) from the NW node 200 (e.g., according to the FIG. 8) or a combination of RRC and MAC message from NW node. The embodiments are applicable for activation/deactivation of any type of serving cell e.g. SCell, PSCell etc.

The carrier frequency on which the UE 100 is configured to perform the procedure (e.g. serving cell activation, cell change, etc.) may belong to certain frequency range (FR). Examples of FR are within frequency range 1 (FR1), within frequency range 2 (FR2), within frequency range 3 (FR3) etc. In one example frequencies within FR2 are frequencies above certain threshold e.g. 24 GHz or higher. In another example the frequencies in FR2 may vary between 24 GHz to 52.6 GHz. In another example frequencies in FR2 may vary between 24 GHz to 71 GHz. Frequencies in FR1 are below the frequencies in FR2. In one example frequencies in FR1 range between 410 MHz and 7125 MHz. In higher frequencies (e.g. mm-wave, FR2, FR3, etc.) due to higher signal dispersion, the transmitted signals are beamformed by a base station e.g. transmitted in terms of SSB beams. The beam based transmission and/or reception may also be used in lower frequencies e.g. in FR1. The UE creates a receive (RX) beam at its receiver to receive the signal (e.g. PRS, SSB, CSI-RS, etc.). A DL RS (e.g. PRS, SSB, CSI-RS etc) may therefore interchangeably be called as a DL beam, spatial filter, spatial domain transmission filter, main lobe of the radiation pattern of antenna array etc. The term beam used herein may refer to RS such as PRS, SSB, CSI-RS etc. The RS or beams may be addressed or configured by an identifier, which can indicate the location of the beam in time in beam pattern e.g. beam index such as PRS index indicate PRS beam location in the pre-defined PRS format/pattern, beam index such as SSB index indicate SSB beam location in the pre-defined SSB format/pattern etc. The measurement on such RS may also be called as beam measurement or beam based measurement. The UE may also combine two or more beam measurements to obtain a combine or overall measurement result.

A first detailed method embodiment, comprises the method 300 in a UE 100 for transmitting 308 a serving cell measurement report triggered by serving cell activation 304.

A first detailed embodiment of the method 300 in a UE 100 served by a first cell (Cell1), which is managed or operated by a first network node (NW1) 200, comprises:
receiving 304 a serving cell activation command (e.g., the activation command for an SCell or an SCG) to activate a second cell 502 (Cell2);
determining 306 whether to transmit 308 a measurement report for a measurement performed 302 on the Cell2 200 to the NW1 200 based on one or more rules; and
transmitting 308 the measurement report to the NW1 200, if it is determined to transmit 308 the measurement report.

The UE 100 receives 304 the activation command for the serving cell 502 from the NW1 200 at a reference time instance (TR). The measurement report may comprise results of one or more measurements performed by the UE 100 on the Cell2 502, e.g. a RSRP, a RSRQ, and/or SINR, etc., and/or an index thereof.

The UE 100 further activates the Cell2 502, e.g. transmits 312 a valid CSI results upon successful completion of the activation of the Cell2 502. Examples of valid CSI are a CQI with non-zero index, and/or a L1-RSRP within reportable range (e.g., equal to or greater than 15), etc. For example, the UE 100 may complete the serving cell activation, i.e, the Cell2 502 becomes activated, at a certain time instance (T_{E}). In this case, the serving cell activation delay for activating the Cell2 502 may be broadly expressed as (T_{E}-T_{R}).

The motivation of this reporting mechanism can be that the UE 100 might have measured the cell 502 to be activated (i.e., the Cell2, e.g. an SCell or PSCell to be activated), but if the UE 100 was not reporting the measurement 302 done on that cell 502 to the NW1 200, the NW1 200 assumes that cell 502 is unknown. In this case, the activation delay requirements for activating the serving cell 502 (e.g. SCell or PSCell) of the unknown cell has to be met by the UE. There can be multiple reasons for the UE 100 not reporting the measurement results for the cell 502, even though the UE 100 was measuring 302 that cell 502. One such reason could be that the UE 100 is configured with event-triggering reporting and the corresponding event may not have been triggered for that cell 502 even though that was measured by the UE 100 and is within reportable range and/or has acceptable quality, e.g. a SINR is above a predefined threshold.

When the UE 100 measured the cell 502 and has not reported the measurement result to NW1 200, due to the current framework for known and unknown states (e.g., at the NW1 200), the activation delay for activating the serving cell 502 (e.g. SCell activation delay, PSCell activation delay, etc.) is quite large compared to the case when the UE 100 has reported the measurement results.

The one or more rules for determining 306 whether to transmit the measurement report for the measurement performed 302 on the Cell2 502 to the NW1 200 may be predefined (e.g., defined in a technical standard and/or configured by the NW1 200).

Examples of the one or more rules comprise at least one of:
1. In one example of the rule, the UE 100 is required to transmit 308 the measurement report for the Cell2 502 upon receiving 304 the activation command for the serving cell 502, e.g. regardless of any other conditions.
2. In another example of the rule, the UE 100 is required to transmit 308 the measurement report for the Cell2 502 upon receiving the activation command for the serving cell 502, when at least one the following conditions is met.
   a) If the UE has not transmitted the measurement report for Cell2 during the last certain time period (Tx1) before the reception of the serving cell activation command, e.g. no report was sent during (T_{R}-Tx1). Tx1 may be predefined (e.g., defined by a technical specification and/or configured by the NW1 200). In one example, Tx1 is a fixed value (e.g. 5 seconds).
   b) If the Cell2 502 is currently known to the UE 100, but the UE 100 has not transmitted the measurement report for Cell2 during the last certain time period (Tx2) before the reception 304 of the activation command for the serving cell 502, e.g. no report was sent during (T_{R}-Tx2). Tx2 may be predefined (e.g., defined by a technical specification and/or configured by the NW1 200). In one example, Tx2 is a fixed value (e.g. 5 seconds). In another example, Tx2 is equal to the duration over which the cell remains known to the UE 100 (e.g., the minimum time period) even if the UE 100 has not performed 302 the measurement on that cell 502 during Tx2.
   For this condition or any other context, the Cell2 502 may be known to the UE 100 if it meets one or more conditions related to the cell (e.g., SCell) being known (described above or e.g. in below specific example section). In one example, the measurement report transmitted by the UE 100 to the NW1 200 may comprise measured value (e.g. RSRP of −90 dBm) of the measurement performed on Cell2 502. In another example, the UE may the measurement report transmitted by the UE 100 to the NW1 200 may comprise an indicator indicating that the Cell2 502 is known to the UE 100. This latter approach reduces the signaling overheads. The UE 100 determines the reporting mechanism (e.g., the reporting approach) based on the one or more rules (e.g., which may be a predefined rule, optionally defined by a technical specification and/or by a configuration received from NW1 200).
   c) If the Cell2 502 is currently semi-known to the UE but the UE 100 has not transmitted the measurement report for Cell2 during the last certain time period (Tx3) before the reception of the activation command for the serving cell 502, e.g. no report was sent during (T_{R}-Tx3). In one example, Tx3 is a fixed value (e.g. 10 seconds). In another example, Tx3 is equal to the duration over which the cell remains semi-known to the UE even if the UE has not performed measurement on that cell during Tx3. The Cell2 502 is semi-known to the UE if it meets one or more conditions related to the cell being semi-known (e.g., described above or in specific example section). The term semi-known may also interchangeably be called as semi-unknown, quasi-known, quasi-unknown, etc. In one example, the measurement report transmitted 308 by the UE 100 to the NW1 200 may comprise a measured value (e.g. RSRP of −90 dBm) of the measurement performed 302 on the Cell2 502. In another example, the UE 100 may the measurement report transmitted by the UE 100 to the NW1 200 may comprise an indicator indicating that Cell2 502 is semi-known to the UE. This latter approach reduces the signaling overheads. The UE 100 determines the reporting mechanism (e.g., a reporting approach) based on pre-defined rule or configuration received from NW1 200.
   d) If the Cell2 502 is currently unknown to the UE 100. This may also imply that the UE 100 has not (e.g., yet) transmitted 308 the measurement report for the Cell2 502 during the last certain time period (Tx4) before the reception 304 of the activation command for the serving cell 502, e.g. no report was sent during (T_{R}-Tx4). Tx4 can be predefined (e.g., defined by a technical specification and/or configured by the NW1 200). In this case in one exemplary approach, the UE 100 does not transmit 308 any measurement report for the Cell2 502 to the NW1 200. The absence of the measurement report is interpreted by the NW1 200 that the Cell2 502 is unknown to the UE 100. In a second exemplary approach, the UE transmits 308 a message (as an example of the measurement report) to the NW1 200 indicating that the Cell2 502 is unknown to the UE 100. This approach enables NW1 200 to explicitly determine that the Cell2 502 is unknown to the UE 100. The UE 100 may further be configured to transmit 312 the measurement results for Cell2 when Cell2 becomes known or semi-known (e.g. after the UE 100 has measured the Cell2), i.e. at later time but during the serving cell activation procedure. In this case in one example, the UE 100 may transmit 308 the measured value or an indicator indicating that Cell2 has become known or semi-known. The UE 100 determines 306 the reporting mechanism (e.g., the reporting approach) based on the one or more rules (e.g., a predefined rule, e.g. a configuration received from the NW1 200).
3. In another example of the rule, the UE 100 is pre-configured by higher layer signaling (e.g. via a RRC message) that the UE 100 should transmit the measurement report for Cell2 upon receiving serving cell activation command. In this case, in one example the UE transmits the measurement report for Cell2 to NW1 according to Rule #1. In another example the UE 100 transmits the measurement report for Cell2 to NW1 according to Rule #2 i.e. when one or more conditions are met.
4. In another example of the rule, the UE 100 is configured to report the measurement report for measurement performed on Cell2 502 to the NW1 200, if the UE 100 is indicated to report the measurement report of Cell2 by the NW1 200. In some embodiments, the UE 100 may be indicated to report the measurement report for the Cell2 502 through a configuration message sent to the UE 200 by the NW1 200. In one example, the configuration message can be included or added to the activation command (e.g., MAC CE) for the serving cell 502. In another example it can be a separate message (e.g., MAC CE or DCI) sent to the UE 100 along with serving cell activation command or sent at a later point than serving cell activation command. In one example, the UE may be configured with RRC message to indicate measurement report. An example of the configuration message using RRC message may be through the ReportConfigNR, and using the IE e.g., reportSCellUponSCellactivationcommand in the ReportConfigNR.

An example configuration is shown below (with the relevant parameter highlighted).

ReportConfigNR ::= SEQUENCE {
reportType CHOICE {
periodical PeriodicalReportConfig,
eventTriggered EventTriggerConfig,
...,
reportCGI ReportCGI,
reportSFTD ReportSFTD-NR,
condTriggerConfig-r16 CondTriggerConfig-r16,
cli-Periodical-r16 CLI-PeriodicalReportConfig-r16,
cli-EventTriggered-r16 CLI-EventTriggerConfig-r16,
rxTxPeriodical-r17 RxTxPeriodical-r17
reportSCellUponSCellactivationcommand enumerated {true}
}
}

5. In any of the above rules numbered 1 to 4, the UE 100 may further be configured to transmit 308 the measurement report for the one or more measurements performed 302 on the Cell2 502 based on the relation between the measurement value and one or more thresholds. Examples are:
   a) In one example, the UE transmits the measurement report provided that the measurement value is above certain threshold e.g. RSRP>H11 and/or RSRQ>H12.
   b) In another example, the UE transmits the measurement report provided that the measurement value of Cell2 is not more than certain threshold below the measurement value of Cell1 e.g. [RSRP2>(RSRP1-H21) and/or RSRQ2>(RSRQ1-H22)]. Where RSRP1 and RSRQ1 are measured on Cell1 and RSRP2 and RSRQ2 are measured on Cell2.

Below first specific example section comprises examples of an activation procedure for the serving cell 502 with measurement reporting 308. The following section describes a specific example of the serving cell activation procedure for activating Cell2 when the UE is also triggered to transmit measurement reporting for Cell2:

When the parameter reportSCellUponSCellactivationcommand is set as true, performing the SCell activation as per following steps.
Step 0-1: Determining validMeasurmentReportAvailable based on one or more of the following scenarios or rules.
   If the Cell2 status at UE is not known (e.g., can be unknown or any other state than known such as quasi-known state) as per the SCell or SCG known condition definition, e.g. as defined in the 3GPP document TS 38.133, version 17.7.0
   If the Cell2 status is not known, and if all the below conditions are true, set validMeasurmentReportAvailable as true.
      UE has performed measurement of the Cell2 in the last X seconds (e.g., X may be 5 seconds), and
      If UE has not reported the measurement report of the Cell 2 to the NW node, e.g., due to the event triggered reported is configured and the event report is not triggered for the Cell2 or for any other reason, and
      Cell 2 is detectable and above a certain SNR or SINR threshold when the serving cell activation command is received for the Cell2.
   If the validMeasurmentReportAvailable is true proceed to step 0-2 and if not proceed to the step 0-4.
Step 0-2: transmitting the measurement report to NW
   The UE 100 transmits 308 the measurement report for the activated cell 502 (i.e., the to-be-activated Cell2 502) with the SSB index based on the method 300 or the above-mentioned first detailed method embodiment.
   If the UE 100 is configured with periodic reporting, include the Cell 2 measurement report in the next occasion of periodic measurement report to the NW node 200.
   If the UE 100 is configured with event triggered measurement reporting, UE triggering of the event for measurement report. Where the event that gets triggered for sending measurement report is SCell activation event. In the event triggered measurement report, including the Cell 2 measurement report in the next occasion of event triggered measurement report to the NW node 200.
   If there is no configured measurement reporting, when configured to do so, the UE 100 may trigger transmitting the UE assistant information (e.g., as an example of the measurement report of the step 308) to include the measurement report for the to-be-activated Cell 2 to NW. If the NW 200 configures an activation command for the SCell 502, the UE 100 finds it has measured the SCell but not report the measurement report to NW 200, the UE 100 can signal the network 200 through UEAssistanceInformation (e.g., as an example of the measurement report of the step 308) to indicate the measurement quality (and optionally related SSB index) to the NW 200 by RRC and/or NAS signaling. After the UE transmits 308 the measurement report with the SSB index, if the UE 100 does not receive the Transmission Configuration Indicator (TCI) from the NW 200, the UE 100 will further report 308 the L1-RSRP reporting to NW to indicate the candidate SSB index.
   Proceed to step 0-3.
Step 0-3: perform SCell activation procedures as below
   In some embodiments, NW indicating to the UE whether the first data beam after SCell activation is wide beam or narrow beam.
   If the first data transmission is based on wide beam,
      Waiting for the TCI indication from NW.
      Skipping the AGC retuning and cell search for the Cell2 activation
   If the first data transmission is based on narrow beam, UE
      Skips the AGC retuning and cell search for the Cell2 activation.
      Performing L1-RSRP measurement and sends the L1-RSRP measurement reporting upon finishing the L1-RSRP measurement.
      UE 100 waits the TCI indication from NW 200.
      UE 100 performs fine timing tracking after receiving the TCI indication.
      UE 100 measures the CSI-RS quality and transmits the CSI-RS reporting.
Step 0-4: perform SCell activation procedures as below:
   Perform serving cell activation as unknown serving cell (e.g., unknown SCell or unknown SCG) activation as per the 3GPP document TS 38.133, version 17.7.0.

When the parameter reportSCellUponSCellactivationcommand is set as false, performing the SCell activation as per following steps.
Step 1-1: Determining validMeasurmentReportAvailable based on one or more of the following scenarios or rules.
   If the Cell2 status at UE is not known (e.g., can be unknown or any other state than known such as quasi-known state) as per the SCell or SCG known condition definition defined in the 3GPP document TS 38.133, version 17.7.0,
   If the Cell2 status is not known, and if all the below conditions are true, validMeasurmentReportAvailable as true.
      UE has performed measurement of the Cell2 in the last X seconds (e.g., X may be 5 seconds), and
      If UE has not reported the measurement report of the Cell 2 to the NW node, e.g., due to the event triggered reported is configured and the event report is not triggered for the Cell2 or for any other reason, and
      Cell 2 is detectable and above a certain SNR or SINR threshold when the serving cell activation command is received for the Cell2
   If the validMeasurmentReportAvailable is true proceed to step 1-2 and if not proceed to step 1-3.
Step 1-2: perform SCell activation procedures as below:
   In some embodiments, NW indicating to the UE whether the first data beam after SCell activation is wide beam or narrow beam.
   If the first data transmission is based on wide beam,
      Waiting for the TCI indication from NW
      Skipping the AGC retuning and cell search for the Cell2 activation
   If the first data transmission is based on narrow beam, UE.
      Skips the AGC retuning and cell search for the Cell2 activation.
      Performing L1-RSRP measurement and sends the L1-RSRP measurement reporting upon finishing the L1-RSRP measurement
      UE 100 waits the TCI indication from NW 200.
      UE 100 performs fine timing tracking after receiving the TCI indication.
      UE 100 measures the CSI-RS quality and transmits the CSI-RS reporting.
Step 1-3: perform SCell activation procedures as below (e.g., as an alternative to the above step 1-2)
   Perform serving cell activation as unknown serving cell (e.g., unknown SCell or unknown SCG) activation as per the 3GPP document TS 38.133, version 17.7.0.

Below second specific example section provides examples related to a method 300 in a UE 100 for determining 306 the state of a cell (known, unknown or semi-known). The following examples describe the one or more conditions under which the UE determines the state of a cell (Cell2) i.e. whether Cell2 is known, unknown or semi-known (also referred to as quasi-known).

### Examples Related to Cell2 502 Belonging to FR1:

Cell2 (e.g. serving cell) in FR1 band is known if it has been meeting the following conditions:
   During a time period, T11, before the reception of the command related to the procedure (e.g. serving cell activation command):
      the UE has sent a valid measurement report for Cell2 (e.g. serving cell being activated) and
      the RS measured (e.g. M1 such as SSB measured) remains detectable according to the cell identification conditions.
   the RS measured (e.g. M1 such as SSB measured) during the time period T11 also remains detectable during the completion of the procedure (e.g. serving cell activation delay) according to the cell identification conditions.
Cell2 in FR1 is quasi-known if it has been meeting the following conditions:
   During a time period, T12, before the reception of the command related to the procedure (e.g. serving cell activation command):
      the UE has sent a valid measurement report for Cell2 (e.g. serving cell being activated) and
      the RS measured (e.g. M1 such as SSB measured) remains detectable according to the cell identification conditions.
   the RS measured (e.g. M1 such as SSB measured) during the time period T12 also remains detectable during the completion of the procedure (e.g. serving cell activation delay) according to the cell identification conditions.
   UE is in low mobility and Cell1 signal strength did not change more than a threshold H4 over a period of time T12.
   Where T12>T11:
      In one example, T11=5 seconds and T12=30 seconds.
      In another example, T11=max (L11*measCycleSCell,
      L11*DRX cycles) and T12=max (L12*measCycleSCell,
      L12*DRX cycles). Wherein, L12>L11. In one example, L11=5 and L12=10.
Otherwise Cell2 in FR1 is unknown.
   This may be the case when for example, the UE has not performed M1 or performed M1 before T12 or does not meet the cell identification requirement during T11 or T12 or during the completion of the procedure.

In the above example, the examples of the cell identification conditions are:
One or more RS measurements (e.g. RSRP, RSRQ, SINR, etc.) meet their conditions for the band of Cell2 e.g. total received power including interference (Io) is within a range such as between maximum and minimum values.
RS received level (e.g. SSB received signal level) at the UE is above threshold for the band of Cell2.
RS Ês/lot (e.g. SSB Ês/lot) at the UE Cell2 is above certain threshold.

### Examples Related to Cell2 Belonging to FR2:

Cell2 (e.g. serving cell) in FR2 band is known if it has been meeting the following conditions:
   During a time period, T21, before UE receives the last command related to the procedure (e.g. serving cell activation command for one or more TCIs associated with corresponding channels (e.g. PDCCH TCI, PDSCH TCI (when applicable)) and for measurement reporting (e.g. semi-persistent CSI-RS for CQI reporting (when applicable)):
      the UE has sent a valid measurement report (e.g. L3-RSRP) with RS index (e.g. SSB index)
      the command related to the procedure (e.g. serving cell activation command) is received after the measurement reporting (e.g. L3-RSRP reporting) and no later than the time when UE receives a command for TCI activation (e.g. MAC-CE command for TCI activation).
   During the period from measurement report (e.g. L3-RSRP) to the valid CQI reporting, the reported RSs indexes (e.g. SSBs indexes) remain detectable according to the cell identification conditions, and the TCI state is selected based on one of the latest reported RSs indexes (e.g. SSBs indexes).
Cell2 (e.g. serving cell) in FR2 band is quasi-known if it has been meeting the following conditions:
   During a time period, T22, before UE receives the last command related to the procedure (e.g. serving cell activation command for one or more TCIs associated with corresponding channels one or more channels (e.g. PDCCH TCI, PDSCH TCI (when applicable)) and for measurement reporting (e.g. semi-persistent CSI-RS for CQI reporting (when applicable)):
      the UE has sent a valid measurement report (e.g. L3-RSRP) with RS index (e.g. SSB index)
      the command related to the procedure (e.g. serving cell activation command) is received after the measurement reporting (e.g. L3-RSRP reporting) and no later than the time when UE receives a command for TCI activation (e.g. MAC-CE command for TCI activation).
   During the period from measurement report (e.g., L3-RSRP) to the valid CQI reporting, the reported RSs indexes (e.g. SSBs indexes) remain detectable according to the cell identification conditions, and the TCI state is selected based on one of the latest reported RSs indexes (e.g. SSBs indexes).
   UE is in low mobility and the Cell 1 or SpCell quality did not change more than certain threshold over a period of time T22.
   Where T22>T21:
      1. In one example, T21=4 seconds and T22=20 seconds.
      2. In another example, T21 and/or T22 depend on the UE power class. In one example, T21=4 s for UE power classes 1 and 5 and T21=3 s for UE power classes 2, 3 and 4. In another example, T22=20 s for UE power classes 1 and 5 and T22=15 s for UE power classes 2, 3 and 4. The UE power class defines maximum output power supported by the UE, which may further depend on the band.
Otherwise Cell2 in FR2 band is unknown.
   This may be the case when for example, the UE does not meet one or more conditions related to known or quasi-known states as described above.
   The requirement for Cell2 in unknown state (e.g. when the serving cell to be activated is unknown) applies provided that the command or messages for one or more TCI associated with corresponding channels (e.g. activation commands for PDCCH TCI, PDSCH TCI (when applicable), for measurement reporting (e.g. semi-persistent CSI-RS for CQI reporting (when applicable)), and for configuration message for TCI of periodic measurement reporting (e.g. CSI-RS for CQI reporting (when applicable)) are based on the latest valid measurement reporting (e.g. valid L1-RSRP reporting).

In the above example, the examples of the cell identification conditions are the same as stated for Cell2 in FR1 band.

A second detailed embodiment comprises an embodiment of the method 400 in a network node 200 (e.g., the base station) for triggering a UE 100 to transmit 308 a measurement report for the serving cell 502 upon activation of a serving cell 502. According to a second detailed embodiment, a first network node 200 (NW1) which serves or manages Cell1 (e.g., the cell serving the UE 100):
configures the UE 100 served by the Cell1 to transmit a measurement report related to a measurement performed by the UE 100 on the Cell2 502 to the NW1 200 upon receiving an activation command to activate Cell2, and
receives 408 the measurement report for Cell2 from the UE.

The NW1 200 may further uses the received the measurement report for Cell2 from the UE for performing one or more operational tasks. Examples of the operational tasks are NW1 determining the serving cell activation delay for Cell2, scheduling the UE with data upon completion of the activation of Cell2, etc.

In one example, the NW1 200 may configure the UE 100 to transmit 308 the measurement report for the Cell2 502 in a separate message (e.g. pre-configures the UE before sending the Cell2 activation command). In another example, NW1 may configure the UE to transmit the measurement report for Cell2 in the same message sent for activating Cell2 (e.g. the Cell2 activation command).

Alternatively or in addition, the NW1 200 configures the UE 100 to transmit the measurement report to NW1 based on one or more rules, which are the same as described in the UE embodiments (e.g., the method 300 or the above-mentioned first detailed method embodiment).

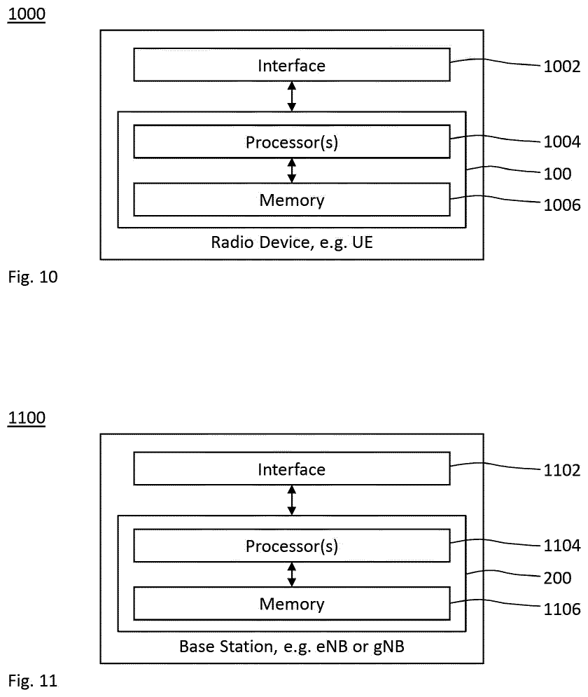

FIG. 10 shows a schematic block diagram for an embodiment of the device 100. The device 100 comprises processing circuitry, e.g., one or more processors 1004 for performing the method 300 and memory 1006 coupled to the processors 1004. For example, the memory 1006 may be encoded with instructions that implement at least one of the modules 104 and 108.

The one or more processors 1004 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 1006, radio device functionality. For example, the one or more processors 1004 may execute instructions stored in the memory 1006. Such functionality may include providing various features and steps discussed herein, including any of the benefits disclosed herein. The expression “the device being operative to perform an action” may denote the device 100 being configured to perform the action.

As schematically illustrated in FIG. 10, the device 100 may be embodied by a radio device 1000, e.g., functioning as a UE. The radio device 1000 comprises a radio interface 1002 coupled to the device 100 for radio communication with one or more cells and base stations, e.g., functioning as a gNB.

FIG. 11 shows a schematic block diagram for an embodiment of the device 200. The device 200 comprises processing circuitry, e.g., one or more processors 1104 for performing the method 400 and memory 1106 coupled to the processors 1104. For example, the memory 1106 may be encoded with instructions that implement at least one of the modules 204 and 208.

The one or more processors 1104 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200, such as the memory 1106, base station functionality. For example, the one or more processors 1104 may execute instructions stored in the memory 1106. Such functionality may include providing various features and steps discussed herein, including any of the benefits disclosed herein. The expression “the device being operative to perform an action” may denote the device 200 being configured to perform the action.

As schematically illustrated in FIG. 11, the device 200 may be embodied by a base station 1100, e.g., functioning as gNB. The base station 1100 comprises a radio interface 1102 coupled to the device 200 for radio communication with one or more radio devices, e.g., functioning as UEs.

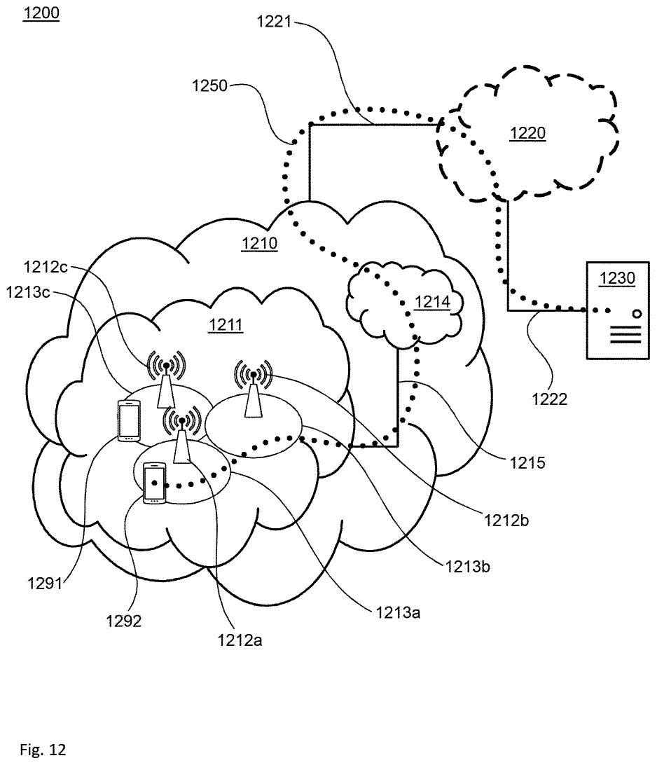

With reference to FIG. 12, in accordance with an embodiment, a communication system 1200 includes a telecommunication network 1210, such as a 3GPP-type cellular network, which comprises an access network 1211, such as a radio access network, and a core network 1214. The access network 1211 comprises a plurality of base stations 1212a, 1212b, 1212c, such as NBs, eNBs, gNBs or other types of wireless access points, each defining a corresponding coverage area 1213a, 1213b, 1213c. Each base station 1212a, 1212b, 1212c is connectable to the core network 1214 over a wired or wireless connection 1215. A first user equipment (UE) 1291 located in coverage area 1213c is configured to wirelessly connect to, or be paged by, the corresponding base station 1212c. A second UE 1292 in coverage area 1213a is wirelessly connectable to the corresponding base station 1212a. While a plurality of UEs 1291, 1292 are illustrated in this example, the disclosed embodiments are equally applicable to a situation where a sole UE is in the coverage area or where a sole UE is connecting to the corresponding base station 1212.

Any of the base stations 1212 may embody the device 200. Alternatively or in addition, any of the UEs 1291, 1292 may embody the device 100.

The telecommunication network 1210 is itself connected to a host computer 1230, which may be embodied in the hardware and/or software of a standalone server, a cloud-implemented server, a distributed server or as processing resources in a server farm. The host computer 1230 may be under the ownership or control of a service provider, or may be operated by the service provider or on behalf of the service provider. The connections 1221, 1222 between the telecommunication network 1210 and the host computer 1230 may extend directly from the core network 1214 to the host computer 1230 or may go via an optional intermediate network 1220. The intermediate network 1220 may be one of, or a combination of more than one of, a public, private or hosted network; the intermediate network 1220, if any, may be a backbone network or the Internet; in particular, the intermediate network 1220 may comprise two or more sub-networks (not shown).

The communication system 1200 of FIG. 12 as a whole enables connectivity between one of the connected UEs 1291, 1292 and the host computer 1230. The connectivity may be described as an over-the-top (OTT) connection 1250. The host computer 1230 and the connected UEs 1291, 1292 are configured to communicate data and/or signaling via the OTT connection 1250, using the access network 1211, the core network 1214, any intermediate network 1220 and possible further infrastructure (not shown) as intermediaries. The OTT connection 1250 may be transparent in the sense that the participating communication devices through which the OTT connection 1250 passes are unaware of routing of uplink and downlink communications. For example, a base station 1212 need not be informed about the past routing of an incoming downlink communication with data originating from a host computer 1230 to be forwarded (e.g., handed over) to a connected UE 1291. Similarly, the base station 1212 need not be aware of the future routing of an outgoing uplink communication originating from the UE 1291 towards the host computer 1230.

By virtue of the method 300 being performed by any one of the UEs 1291 or 1292 and/or the method 400 being performed by any one of the base stations 1212, the performance or range of the OTT connection 1250 can be improved, e.g., in terms of increased throughput and/or reduced power consumption due to more accurately controlled time of the SCell 502 being active. More specifically, the host computer 1230 may indicate to the RAN 1211 or one of the UEs acting as relay radio device 200 or gateway 200, or to one of the UEs acting as the radio device 100 (e.g., on an application layer) a required data rate or a data volume, which may trigger the activation of the SCell 502 according to the subject technique.

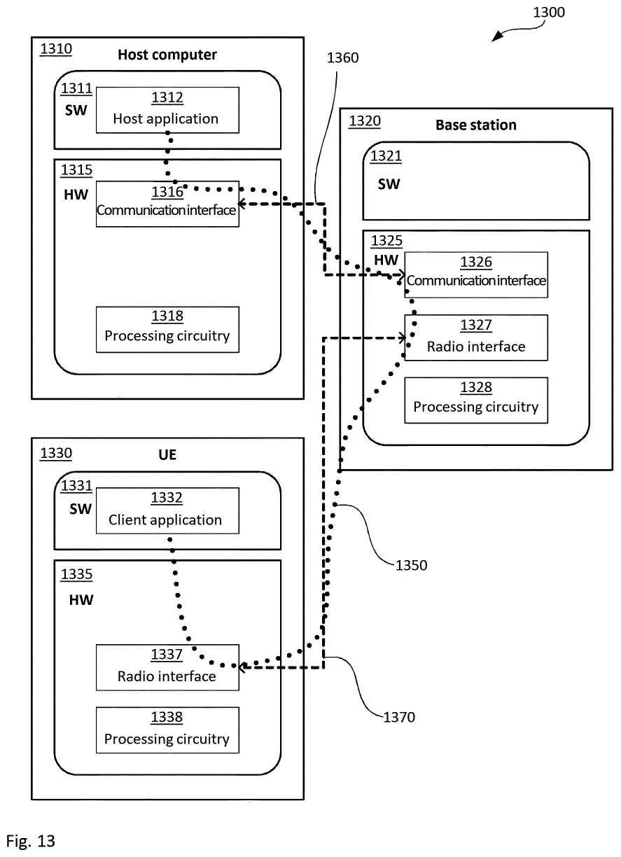

Example implementations, in accordance with an embodiment of the UE, base station and host computer discussed in the preceding paragraphs, will now be described with reference to FIG. 13. In a communication system 1300, a host computer 1310 comprises hardware 1315 including a communication interface 1316 configured to set up and maintain a wired or wireless connection with an interface of a different communication device of the communication system 1300. The host computer 1310 further comprises processing circuitry 1318, which may have storage and/or processing capabilities. In particular, the processing circuitry 1318 may comprise one or more programmable processors, application-specific integrated circuits, field programmable gate arrays or combinations of these (not shown) adapted to execute instructions. The host computer 1310 further comprises software 1311, which is stored in or accessible by the host computer 1310 and executable by the processing circuitry 1318. The software 1311 includes a host application 1312. The host application 1312 may be operable to provide a service to a remote user, such as a UE 1330 connecting via an OTT connection 1350 terminating at the UE 1330 and the host computer 1310. In providing the service to the remote user, the host application 1312 may provide user data, which is transmitted using the OTT connection 1350. The user data may depend on the location of the UE 1330. The user data may comprise auxiliary information or precision advertisements (also: ads) delivered to the UE 1330. The location may be reported by the UE 1330 to the host computer, e.g., using the OTT connection 1350, and/or by the base station 1320, e.g., using a connection 1360.

The communication system 1300 further includes a base station 1320 provided in a telecommunication system and comprising hardware 1325 enabling it to communicate with the host computer 1310 and with the UE 1330. The hardware 1325 may include a communication interface 1326 for setting up and maintaining a wired or wireless connection with an interface of a different communication device of the communication system 1300, as well as a radio interface 1327 for setting up and maintaining at least a wireless connection 1370 with a UE 1330 located in a coverage area (not shown in FIG. 13) served by the base station 1320. The communication interface 1326 may be configured to facilitate a connection 1360 to the host computer 1310. The connection 1360 may be direct, or it may pass through a core network (not shown in FIG. 13) of the telecommunication system and/or through one or more intermediate networks outside the telecommunication system. In the embodiment shown, the hardware 1325 of the base station 1320 further includes processing circuitry 1328, which may comprise one or more programmable processors, application-specific integrated circuits, field programmable gate arrays or combinations of these (not shown) adapted to execute instructions. The base station 1320 further has software 1321 stored internally or accessible via an external connection.

The communication system 1300 further includes the UE 1330 already referred to. Its hardware 1335 may include a radio interface 1337 configured to set up and maintain a wireless connection 1370 with a base station serving a coverage area in which the UE 1330 is currently located. The hardware 1335 of the UE 1330 further includes processing circuitry 1338, which may comprise one or more programmable processors, application-specific integrated circuits, field programmable gate arrays or combinations of these (not shown) adapted to execute instructions. The UE 1330 further comprises software 1331, which is stored in or accessible by the UE 1330 and executable by the processing circuitry 1338. The software 1331 includes a client application 1332. The client application 1332 may be operable to provide a service to a human or non-human user via the UE 1330, with the support of the host computer 1310. In the host computer 1310, an executing host application 1312 may communicate with the executing client application 1332 via the OTT connection 1350 terminating at the UE 1330 and the host computer 1310. In providing the service to the user, the client application 1332 may receive request data from the host application 1312 and provide user data in response to the request data. The OTT connection 1350 may transfer both the request data and the user data. The client application 1332 may interact with the user to generate the user data that it provides.

It is noted that the host computer 1310, base station 1320 and UE 1330 illustrated in FIG. 13 may be identical to the host computer 1230, one of the base stations 1212a, 1212b, 1212c and one of the UEs 1291, 1292 of FIG. 12, respectively. This is to say, the inner workings of these entities may be as shown in FIG. 13, and, independently, the surrounding network topology may be that of FIG. 12.

In FIG. 13, the OTT connection 1350 has been drawn abstractly to illustrate the communication between the host computer 1310 and the UE 1330 via the base station 1320, without explicit reference to any intermediary devices and the precise routing of messages via these devices. Network infrastructure may determine the routing, which it may be configured to hide from the UE 1330 or from the service provider operating the host computer 1310, or both. While the OTT connection 1350 is active, the network infrastructure may further take decisions by which it dynamically changes the routing (e.g., on the basis of load balancing consideration or reconfiguration of the network).

The wireless connection 1370 between the UE 1330 and the base station 1320 is in accordance with the teachings of the embodiments described throughout this disclosure. One or more of the various embodiments improve the performance of OTT services provided to the UE 1330 using the OTT connection 1350, in which the wireless connection 1370 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 1350 between the host computer 1310 and UE 1330, in response to variations in the measurement results. The measurement procedure and/or the network functionality for reconfiguring the OTT connection 1350 may be implemented in the software 1311 of the host computer 1310 or in the software 1331 of the UE 1330, or both. In embodiments, sensors (not shown) may be deployed in or in association with communication devices through which the OTT connection 1350 passes; the sensors may participate in the measurement procedure by supplying values of the monitored quantities exemplified above, or supplying values of other physical quantities from which software 1311, 1331 may compute or estimate the monitored quantities. The reconfiguring of the OTT connection 1350 may include message format, retransmission settings, preferred routing etc.; the reconfiguring need not affect the base station 1320, and it may be unknown or imperceptible to the base station 1320. Such procedures and functionalities may be known and practiced in the art. In certain embodiments, measurements may involve proprietary UE signaling facilitating the host computer's 1310 measurements of throughput, propagation times, latency and the like. The measurements may be implemented in that the software 1311, 1331 causes messages to be transmitted, in particular empty or “dummy” messages, using the OTT connection 1350 while it monitors propagation times, errors etc.

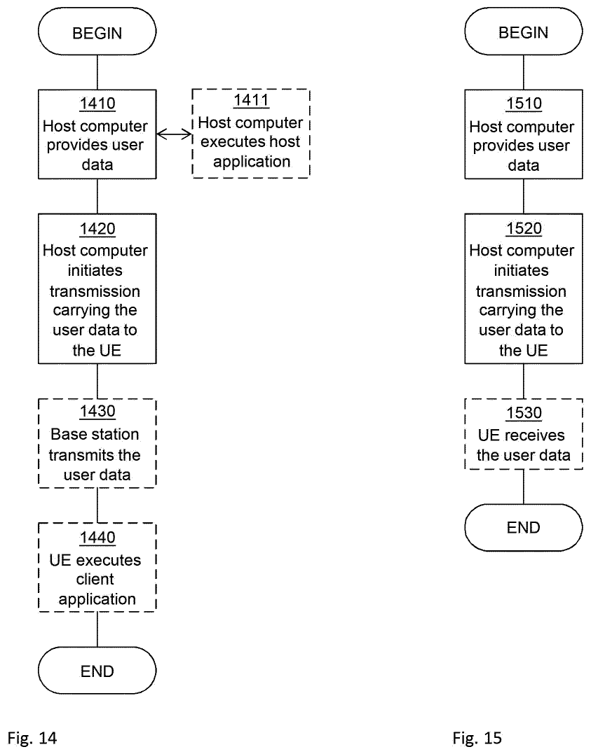

FIG. 14 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 14 will be included in this paragraph. In a first step 1410 of the method, the host computer provides user data. In an optional substep 1411 of the first step 1410, the host computer provides the user data by executing a host application. In a second step 1420, the host computer initiates a transmission carrying the user data to the UE. In an optional third step 1430, the base station transmits to the UE the user data which was carried in the transmission that the host computer initiated, in accordance with the teachings of the embodiments described throughout this disclosure. In an optional fourth step 1440, the UE executes a client application associated with the host application executed by the host computer.

FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this paragraph. In a first step 1510 of the method, the host computer provides user data. In an optional substep (not shown) the host computer provides the user data by executing a host application. In a second step 1520, the host computer initiates a transmission carrying the user data to the UE. The transmission may pass via the base station, in accordance with the teachings of the embodiments described throughout this disclosure. In an optional third step 1530, the UE receives the user data carried in the transmission.

As has become apparent from above description, at least some embodiments of the technique reduce the SCell activation delay for at least some scenarios, e.g., as discussed above. Same or further embodiments can reduce energy consumption during operation of the radio devices and/or the base stations, e.g. because the time during which the cell activated according to embodiments of the technique is in the active state can be reduced, e.g., by more accurately timing the active state. The energy improvement can be observed at the level of node equipment (e.g., individual base stations) or at the network level (e.g., for the RAN).

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

1.-38. (canceled)

39. A method performed by a radio device for activating a cell of a radio access network (RAN), the method comprising:
receiving from the RAN an activation command indicative of activating the cell for multi-carrier operation of the radio device; and
responsive to the activation command, transmitting to the RAN a layer-3 measurement report indicative of a measurement for the activated cell, wherein one or more of the following applies:
the layer-3 measurement report is transmitted without performing a further measurement for the activated cell after the receiving of the activation command, and
the measurement for the activated cell, as indicated by the layer-3 measurement report, was performed prior to receiving the activation command.

40. The method of claim 39, wherein one or more of the following applies: the activated cell is a secondary cell (SCell), and the multi-carrier operation comprises carrier aggregation (CA).

41. The method of claim 39, wherein one or more of the following applies: the activated cell is a primary secondary cell (PSCell) of a secondary cell group SCG) or a secondary cell (SCell) of the SCG, and the multi-carrier operation comprises dual connectivity (DC).

42. The method of claim 39, wherein the measurement for the activated cell, as indicated by the layer-3 measurement report, was not reported to the RAN prior to receiving the activation command.

43. The method of claim 39, further comprising determining whether to transmit the layer-3 measurement report based on one or more rules for transmitting measurement reports responsive to activation commands, wherein the layer-3 measurement report is selectively transmitted according to a result of the determination.

44. The method of claim 43, further comprising receiving from the RAN a configuration message that includes or indicates the one or more rules.

45. The method of claim 39, further comprising one or more of the following first operations:
performing fine time synchronization relative to the activated cell, based on one of the following received from the activated cell: a secondary synchronization signal (SSS) or a synchronization signal block (SSB) received from the activated cell;
measuring one or more of the following for the activated cell: reference signal received power (RSRP), reference signal received quality (RSRQ), and channel quality indicator (CQI), wherein the measuring is based on one or more of the following: the SSB, and a channel state information reference signal (CSI-RS) received from the activated cell; and
performing receiver (RX) beam sweeping on the activated cell,
wherein the first operations are performed after one or more of the following: receiving the activation command, and transmitting the layer-3 measurement report.

46. The method of claim 45, further comprising transmitting to the RAN a valid channel state information (CSI) report based on at least one of the RSRP, the RSRQ, and the CQI measured for the activated cell, wherein the valid CSI report is transmitted after one or more of the following: receiving the activation command, and transmitting the layer-3 measurement report.

47. The method of claim 39, wherein the measurement report does not include results of the measurement for the activated cell.

48. The method of claim 39, wherein the measurement report is indicative of one or more of the following:
the radio device having performed the measurement for the activated cell; and
whether the measurement on the activated cell has already been performed.

49. The method of claim 39, wherein the measurement report is indicative of one of the following:
whether the measurement on the activated cell is not older than a predefined maximum time period, or
whether the measurement on the activated cell was performed within the predefined maximum time period before receiving the activation command.

50. The method of claim 39, further comprising determining whether the radio device has a valid measurement report for the activated cell to transmit, wherein the layer-3 measurement report is selectively transmitted according to a result of the determination.

51. The method of claim 50, wherein the measurement report is indicative of the whether the radio device has one of the following for the activated cell: a valid measurement, or a valid measurement report.

52. The method of claim 39, wherein the measurement report is indicative of whether the RAN should allocate radio resource for the radio device in the activated cell, prior to the RAN receiving from the radio device a valid measurement report for the activated cell.

53. The method of claim 39, wherein the activation command comprises one or more of the following:
a medium access control (MAC) control element (CE); or
a radio resource control (RRC) message indicative of a direct activation of the cell.

54. A radio device configured to activate a cell of a radio access network (RAN), the radio device comprising:
processing circuitry; and
memory operably coupled to the processing circuitry and storing instructions that, when executed by the processing circuitry, configure the radio device to:
receive from the RAN an activation command indicative of activating the cell for multi-carrier operation of the radio device; and
responsive to the activation command, transmit to the RAN a layer-3 measurement report indicative of a measurement for the activated cell, wherein one or more of the following applies:
the layer-3 measurement report is transmitted without performing a further measurement for the activated cell after the receiving of the activation command, and
the measurement for the activated cell, as indicated by the layer-3 measurement report, was performed prior to receiving of the activation command.

55. The radio device of claim 54, wherein the measurement for the activated cell, as indicated by the layer-3 measurement report, was not reported to the RAN prior to receiving the activation command.

56. The radio device of claim 54, wherein execution of the instructions by the processing circuitry further configures the radio device to perform one or more of the following first operations:
perform fine time synchronization relative to the activated cell, based on one of the following received from the activated cell: a secondary synchronization signal (SSS) or a synchronization signal block (SSB) received from the activated cell;
measure one or more of the following for the activated cell: reference signal received power (RSRP), reference signal received quality (RSRQ), and channel quality indicator (CQI), wherein the measuring is based on one or more of the following: the SSB, and a channel state information reference signal (CSI-RS) received from the activated cell; and
perform receiver (RX) beam sweeping on the activated cell,
wherein the first operations are performed after one or more of the following: the radio device receives the activation command, and the radio device transmits the layer-3 measurement report.

57. The radio device of claim 54, wherein execution of the instructions by the processing circuitry further configures the radio device to transmit to the RAN a valid channel state information (CSI) report based on at least one of the RSRP, the RSRQ, and the CQI measured for the activated cell, wherein the valid CSI report is transmitted after one or more of the following: the radio device receives the activation command, and the radio device transmits the layer-3 measurement report.

58. The radio device of claim 54, wherein the measurement report does not include results of the measurement for the activated cell.
